(19) United States
(12) Patent Application Publication
(10) Pub. No.: US 2015/0103817 A1
(43) Pub. Date: Apr. 16, 2015

(54) GLOBAL TIME SYNCHRONIZATION SERVER FOR WIRELESS DEVICES

(71) Applicant: QUALCOMM Incorporated, San Diego, CA (US)

(72) Inventors: Steven John Kuhn, Santa Clara, CA (US); Lalitaprasad Daita, San Jose, CA (US); Samir Kapoor, Palo Alto, CA (US); Ravi Teja Mallajosyula, San Jose, CA (US)

(73) Assignee: QUALCOMM Incorporated, San Diego, CA (US)

(21) Appl. No.: 14/264,368

(22) Filed: Apr. 29, 2014

Related U.S. Application Data
(60) Provisional application No. 61/890,172, filed on Oct. 11, 2013.

(51) Int. Cl. H04J 3/06; H04W 56/00

(52) U.S. Cl. CPC H04J 3/0658; H04W 56/002
USPC 370/350

(57) ABSTRACT

Synchronization of communication events according to a global time base (GTB). Devices implementing the GTB may be configured to awaken and exchange discovery and service capability information over pre-scheduled channels at time points determined according to the GTB. The GTB may be correlated to Global Positioning System (GPS) system time. A global time server (GTS) is described for providing a local source of accurate clock time relative to the GTB. The GTS may aggregate multiple sources of absolute and/or relative time including GPS and WWAN, select the most accurate source for a mobile environment, track source state transitions, and manage clock drift. Global time clients (GTCs) may receive updates from the GTS and compute offsets for communication events relative to a local clock. The GTC may correct for transport errors from transmission of the updated global time value across modules or sub-components of the devices.

### CROSS REFERENCES

The present Application for Patent claims priority to U.S. Provisional Patent Application No. 61/890,172 by Kuhn et al., entitled “Global Time Synchronization Server for Wireless Devices,” filed Oct. 11, 2013, assigned to the assignee hereof, and expressly incorporated by reference herein.

### BACKGROUND

The following relates generally to wireless communication, and more specifically synchronizing wireless devices across networks or in a disconnected state. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Multiple access wireless systems may have various topologies. In one topology known as a wireless wide area network (WWAN) or cellular system, the system includes a number of base stations that collectively provide coverage for a metropolitan or regional geographic area (e.g., cities, national, etc.). Each base station has a coverage range, which may be referred to as the coverage area of the cell. In another topology known as a wireless local area network (WLAN), an access point forms a network for devices within a local coverage area (e.g., building, house, etc.), and may provide connectivity through the access point to other networks (e.g., the Internet, etc.). WLAN networks employing the IEEE 802.11 family of communication standards are widely deployed and used. A particular implementation of Wi-Fi, Wi-Fi Direct, also known as P2P, is a standard that enables devices to connect easily with each other at Wi-Fi data transfer rates without requiring a dedicated Wi-Fi access point (hard AP). In this technique, a Wi-Fi-Direct enabled device (e.g., a P2P device) can be elected to operate as a soft-AP or Group Owner (GO) for communications with other Wi-Fi devices. In some implementations, the P2P GO can also be used in conjunction with one or more APs to effectively extend the AP(s)'s coverage, adapt to different communication path conditions, and increase throughput of the system.

WLAN systems, such as those employing the IEEE 802.11 family of standards (e.g., Wi-Fi), may use channel sense multiple access (CSMA), in which devices or stations (STA) sense channel conditions prior to accessing the channel. In WLAN systems, access points (AP) may be communicating with several or many other STAs concurrently, and therefore data transfers may be interrupted by periods where the AP is serving other STAs.

### SUMMARY

The described features generally relate to one or more improved systems, methods, and/or apparatuses for performing pre-scheduled communication events according to a global time base (GTB). Devices implementing the GTB may be configured to awaken and exchange discovery and service capability information over pre-scheduled channels at time points determined according to the GTB. A vendor-specific or system-wide event schedule may be determined when the devices and/or networks are provisioned. Additionally or alternatively, new communication events can be scheduled for devices to perform a group rendezvous for ad-hoc networking or exchange of metadata and/or other information. The GTB may be correlated to Global Positioning System (GPS) system time.

The devices may implement a global time server (GTS) for providing a local source of accurate clock time relative to the GTB. The GTS may aggregate multiple sources of absolute and/or relative time including GPS and WWAN, select the most accurate source available in a given mobile environment, track source state transitions (e.g., entering and exiting GPS coverage), and manage clock drift. In one embodiment, the GTS may update the locally-stored global time value based on GPS and may manage local clock drift in-between receipt of GPS signals using relative timing of WWAN signals (e.g., pilot signals, synchronization signals, etc.). The GTS may implement an application programming interface (API) for application level components to retrieve the global time value (e.g., epoch name, translation factor to GTB epoch, offset from the epoch base), and/or a metric of the relative accuracy of the global time value. The GTS may update the global time value for components of the device using a shared memory interface.

The devices and/or networks may implement one or more global time clients (GTCs) for receiving updates from the GTS and computing offsets for communication events relative to a local clock based on the updated global time values and the communication event times relative to the GTB. The GTC may correct for transport errors from transmission of the updated global time value across modules or sub-components (e.g., different integrated circuit (IC) chips, etc.) of the devices. The GTC may receive the global time updates via a shared memory interface and correct for transport error between update of the global time value by the GTS in the shared memory and receipt of the global time value at the GTC.

Some embodiments are directed to a method including determining, at a first communication device, a first global time value for a first communication event, the first global time value related to a global time base, determining a first local time value for the first communication event based at least in part on the first global time value, and communicating with at least a second communication device according to the determined first local time value for the first communication event. The method may include determining, at the first communication device, an event schedule comprising a plurality of communication events, each of the plurality of communication events associated with a global time value correlated to the global time base. In some embodiments, the event schedule is provisioned for the first communication device according to a device class of the first communication device. The method may include determining a communication channel associated with the first communication event for communicating with the at least the second communication device. The global time base may be correlated to Global Positioning System (GPS) system time. Communicating with the at least the second communication device may be performed over a wireless local area network (WLAN) interface.

In some embodiments, communicating with the at least the second communication device includes transitioning from a sleep state to an awake state for a device discovery window at the determined first local time value for the first communication event, establishing a connection with the at least the second communication device in the device discovery window, and exchanging service information with the at least the second communication device over the established connection. The method may include establishing a group rendezvous event schedule with the at least the second communication device, the group rendezvous event schedule comprising a second, future communication event. The method may include determining a communication channel associated with the first communication event for communicating with at least the second communication device.

In some embodiments, determining the first local time for the first communication event includes determining an offset of a local clock to the global time base based on one or more of, signals from one or more entities of a global navigation system, signals from a wireless wide area network (WWAN), or a combination thereof The local clock may be, for example, a system clock of the first communication device. The method may include receiving the first communication event from an application layer of the first communication device.

In some embodiments, the global time base may be correlated to Global Positioning System (GPS) system time. In some embodiments, communicating with at least the second communication device may be performed over a wireless local area network (WLAN) interface.

Some embodiments are directed to an apparatus including means for determining, at a first communication device, a first global time value for a first communication event, the first global time value related to a global time base, means for determining a first local time value for the first communication event based at least in part on the first global time value, and means for communicating with at least a second communication device according to the determined first local time value for the first communication event.

The apparatus may include means for determining, at the first communication device, an event schedule comprising a plurality of communication events, each of the plurality of communication events associated with a global time value correlated to the global time base. The means for communicating with the at least the second communication device may, for the first communication event, transition from a sleep state to an awake state for a device discovery window at the determined first local time value, establish a connection with the at least the second communication device in the device discovery window, and exchange service information with the at least the second communication device over the established connection. The apparatus may include means for establishing a group rendezvous event schedule with at least the second communication device. The group rendezvous event schedule may be a second, future communication event. The apparatus may include means for determining a communication channel associated with the first communication event for communicating with the at least the second communication device. The means for determining the first local time for the first communication event may determine an offset of a local clock to the global time base based on one or more of, signals from one or more entities of a global navigation system, signals from a wireless wide area network (WWAN), or a combination thereof

Some embodiments are directed to a computer program product for a communication device, the computer program product including a non-transitory computer-readable medium, the non-transitory computer-readable medium including instructions executable by a processor to determine, at the communication device, a first global time value for a first communication event, the first global time value related to a global time base, determine a first local time value for the first communication event based at least in part on the first global time value, and communicate with at least a second communication device according to the determined first local time value for the first communication event.

In some embodiments, the non-transitory computer-readable medium includes instructions executable by the processor to determine, at the communication device, an event schedule including a plurality of communication events, where each of the plurality of communication events associated with a global time value correlated to the global time base. The non-transitory computer-readable medium may include instructions executable by the processor to transition from a sleep state to an awake state for a device discovery window at the determined first local time value for the first communication event, establish a connection with the at least the second communication device in the device discovery window, and exchange service information with the at least the second communication device over the established connection. The non-transitory computer-readable medium may include instructions executable by the processor to establish a group rendezvous event schedule with the at least the second communication device, the group rendezvous event schedule comprising a second, future communication event.

Some embodiments are directed to a method for a wireless communication device including receiving a first signal from a first timing source of a global system providing a global time base. The signal may indicate a common reference time value. The method may also involve receiving at least one signal of a plurality of signals transmitted from a second timing source distinct from the global system. The plurality of signals of the second timing source may have a predetermined time interval between consecutive signals. The method may also involve maintaining a global time offset between the local clock and the global time base using the signals received from the first and second timing sources. Further, the method may involve determining a precision level of the determined global time offset based on one or more of an elapsed time since reception of the first signal from the first timing source, an elapsed time since reception of one or more signals of the plurality of signals of the second timing source, or a combination thereof.

In some embodiments, determining the precision level may involve determining whether the determined global time offset is updated using the first timing source. In such embodiments, the method may involve setting the precision level to a first precision value if the global time offset is updated using the first timing source.

In some embodiments, determining the precision level may further involve determining whether the determined global time offset is updated using the second timing source, and determining whether a valid global time signal has been received from the first timing source. In such embodiments, the method may involve setting the precision level to a second precision value if the determined global time offset is updated using the second timing source and a valid global time signal has been received from the first timing source.

In some embodiments, the method may involve setting the precision level to a third precision value if the determined global time offset is not updated using the second timing source and a valid global time signal has been received from the first timing source.

In some embodiments, determining the precision level may further involve determining whether the determined global time offset is valid within a drift tolerance. In such embodiments, the method may involve setting the precision level to a fourth precision value if the determined global time offset is valid within a drift tolerance.

In some embodiments, the method may involve setting the precision level to a fifth precision value if the determined global time offset is not valid within the drift tolerance.

In some embodiments, the method may include performing a communication operation using the determined global time offset. In such embodiments, the method may include receiving an instruction to perform the communication operation at a particular global time and performing the communication operation at the particular global time using the determined global offset.

In some embodiments, receiving the signal from the first timing source includes receiving the signal from an entity of a global navigation system. Receiving the plurality of signals may involve receiving the plurality of signals from a wireless wide area network (WWAN).

In some embodiments, the method includes synchronizing the communication device for a communication event with at least one other communication device using the global time offset. In such embodiments, the wireless communication device may be communicatively disconnected from the at least one other communication device prior to the communication event. In some embodiments, the method includes tracking state transitions of the first timing source with respect to the communication device.

In some embodiments, the method includes receiving a second signal from the first timing source indicating another common reference time value. An updated first time offset with respect to the global time base may be determined using the another common reference time value. An updated global time offset may be determined using the updated first time offset.

Some embodiments are directed to an apparatus for a communication device including means for receiving a first signal from a first timing source of a global system providing a global time base. The signal may indicate a common reference time value. The apparatus also may include means for receiving at least one signal of a plurality of signals transmitted from a second timing source distinct from the global system. The plurality of signals of the second timing source may have a predetermined time interval between consecutive signals. The apparatus may also include means for maintaining a global time offset between the local clock and the global time base using the signals received from the first and second timing sources. The apparatus may further include means for determining a precision level of the determined global time offset based on one or more of an elapsed time since reception of the first signal from the first timing source, an elapsed time since reception of one or more signals of the plurality of signals of the second timing source, or a combination thereof.

Some embodiments are directed to a computer program product for a communication device including a non-transitory computer readable medium storing instructions executable by a processor to receive a first signal from a first timing source of a global system providing a global time base. The signal may indicate a common reference time value. The instructions also may be executable to receive at least one signal of a plurality of signals transmitted from a second timing source distinct from the global system. The plurality of signals of the second timing source may have a predetermined time interval between consecutive signals. The instructions may also be executable to maintain a global time offset between the local clock and the global time base using the signals received from the first and second timing sources. The instructions may further be executable to determine a precision level of the determined global time offset based on one or more of an elapsed time since reception of the first signal from the first timing source, an elapsed time since reception of one or more signals of the plurality of signals of the second timing source, or a combination thereof

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of an example of a wireless communications system;

FIG. 2 is a timing diagram illustrating example use of a global time base to schedule synchronous events between multiple WLAN devices;

FIG. 3 illustrates an example of a global event schedule;

FIG. 4 illustrates an example software stack implementing an API for providing global time values updated by a GTS server;

FIGS. 5A and 5B show block diagrams illustrating example devices that may be configured for performing communication events according to a global time base;

FIG. 6 is a flow chart illustrating an example of a method for performing communication events according to a global time base;

FIG. 7 shows a block diagram of an example of a system for wireless communications;

FIG. 8 shows a timing diagram that illustrates an example timeline for maintaining an offset of the GTB to the local clock at a mobile device;

FIG. 9 illustrates an example of a state diagram representing various operations and data flow for a global time server;

FIG. 10 shows an example of a flowchart illustrating a method that may be used to determine a precision level of locally stored global time value relative to a GTB;

FIG. 11 shows a block diagram of an example of a global time subsystem;

FIG. 12 shows a block diagram of an example of a global time server;

FIG. 13 shows a timing diagram that illustrates an example timeline for determining an offset of the GTB to the local clock at a mobile device for a target time;

FIG. 14 shows an example of a flowchart illustrating a method that may be used to determine a local clock time for executing a communication event;

FIGS. 15A and 15B shows block diagrams of examples of global time clients;

FIGS. 16A and 16B show examples of flowcharts illustrating methods that may be used to maintain a global time offset between a local clock of a wireless communication device and the GTB;

FIG. 17 shows an example of a flowchart illustrating a method that may be used to generate a local time compensation offset for compensating local clock time values; and

FIG. 18 shows a block diagram illustrating an example of hardware that may be used to implement a device for performing communication events according to a global time base.

### DETAILED DESCRIPTION

The described features generally relate to performing pre-scheduled communication events according to a global time base (GTB). Devices implementing the GTB may be configured to awaken and exchange discovery and service capability information over pre-scheduled channels at time points determined according to the GTB. A vendor-specific or system-wide event schedule may be determined when the devices and/or networks are provisioned. Additionally or alternatively, new communication events can be scheduled for devices to perform a group rendezvous for ad-hoc networking or exchange of metadata and/or other information. The GTB may be correlated to Global Positioning System (GPS) system time.

The devices may implement a global time server (GTS) for providing a local source of accurate clock time relative to the GTB. The GTS may aggregate multiple sources of absolute and/or relative time including GPS and WWAN, select the most accurate source available in a given mobile environment, track source state transitions (e.g., entering and exiting GPS coverage), and manage clock drift. In one embodiment, the GTS may update the locally-stored global time value based on GPS and may manage local clock drift in-between receipt of GPS signals using relative timing of WWAN signals (e.g., pilot signals, synchronization signals, etc.). The GTS may implement an application programming interface (API) for application level components to retrieve the global time value (e.g., epoch name, translation factor to GTB epoch, offset from the epoch base), and/or a metric of the relative accuracy of the global time value. The GTS may update the global time value for components of the device using a shared memory interface.

The devices and/or networks may implement one or more global time clients (GTCs) for receiving updates from the GTS and computing offsets for communication events relative to a local clock based on the updated global time values and the communication event times relative to the GTB. The GTC may correct for transport errors from transmission of the updated global time value across modules or sub-components (e.g., different integrated circuit (IC) chips, etc.) of the devices. The GTC may receive the global time updates via a shared memory interface and correct for transport error between update of the global time value by the GTS in the shared memory and receipt of the global time value at the GTC.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

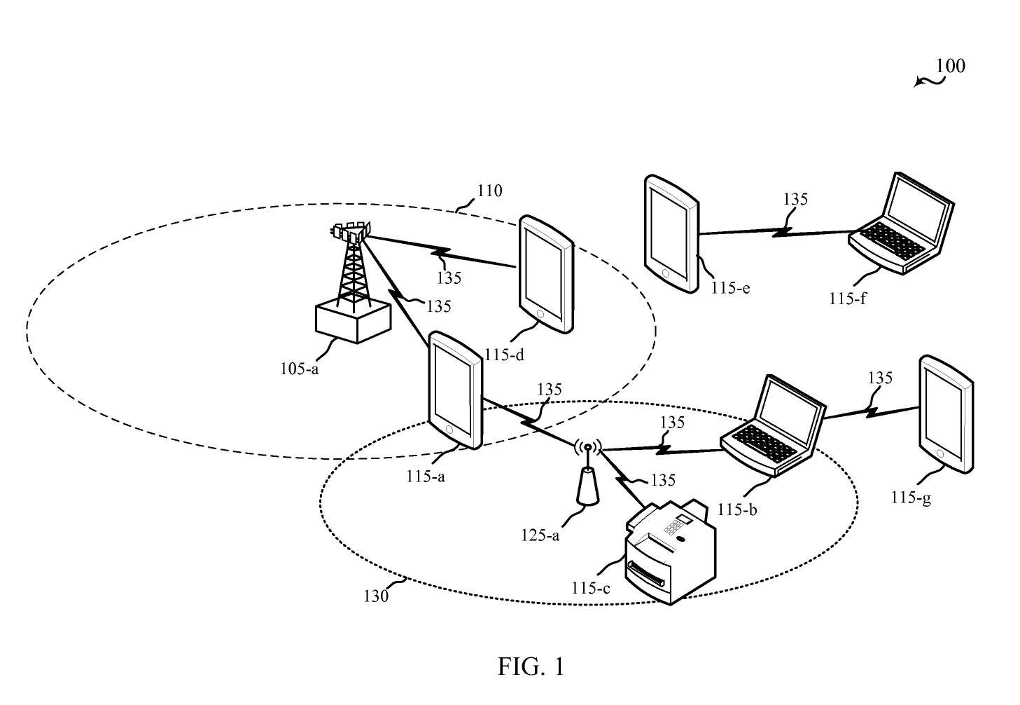

Referring first to FIG. 1, a block diagram illustrates an example of a system 100 employing various networks for wireless communications. Although FIG. 1 shows a system for wireless communications and the following description is presented in terms of wireless communications, various aspects of this disclosure may apply to wired communications, devices and systems, as well as devices and systems that involve both wired and wireless communications. For example, the described techniques for using a global time base to schedule synchronous events and compensation of local clock time values may be utilized by devices to communicate over wired and/or wireless interfaces

The system 100 may include one or more base stations 105 associated with one or more WWAN networks (e.g., CDMA, LTE/LTE-A, etc.) and one or more WLAN access points (APs) 125 (e.g., an IEEE 802.11 network, etc.). The system 100 may include one or more wireless devices 115, such as smartphones, personal digital assistants (PDAs), other handheld devices, netbooks, notebook computers, tablet computers, laptops, display devices (e.g., TVs, computer monitors, etc.), printers, etc. Each of the wireless devices 115, also referred to as wireless stations, stations (STAs), mobile stations (MSs), mobile devices, access terminals (ATs), user equipments (UEs), subscriber stations (SSs), or subscriber units may associate and communicate with the base stations 105 and/or WLAN APs 125 via communication links 125.

WWAN networks generally provide coverage for a wide geographic area (e.g., cities, national, etc.) using a cellular network topology. A WWAN network base station 105 may be called a base station, NodeB, eNodeB (eNB), Home NodeB, a Home eNodeB, or some other suitable terminology. The coverage area 110 for a base station may be divided into sectors making up only a portion of the coverage area (not shown). The term “cell” is a logical concept that can be used to describe carriers at a base station or a coverage area (e.g., sector, etc.) of a base station.

WLAN networks generally provide coverage for a local area (e.g., building, house, etc.). Each WLAN AP 105 has a coverage area 130 such that stations 115 within that area can typically communicate with the AP 105. Although not shown in FIG. 1, a station 115 can be covered by more than one AP 105 and can therefore associate with different APs at different times depending on which one provides a more suitable connection. A single AP 105 and an associated set of stations 115 may be referred to as a basic service set (BSS). An extended service set (ESS) is a set of connected BSSs. A distribution system (DS) (not shown) is used to connect access points in an extended service set.

The transmission links 135 shown in system 100 may include uplink (UL) transmissions from a mobile device 115 to a base station 105 or AP 125, and/or downlink (DL) transmissions, from a base station 105 or AP 125 to a mobile device 115. The downlink transmissions may also be called forward link transmissions while the uplink transmissions may also be called reverse link transmissions.

Within a BSS or ESS, the APs 125 may provide synchronization for the mobile devices to establish reference timing for communication between devices of the BSS/ESS. For example, an AP may provide a beacon signal that is transmitted in a particular time interval and includes a timestamp and information indicating whether DL data is present at the AP 125 for each device 115 of the BSS/ESS. Initially, devices 115 are unconnected to APs 125 and search for the beacon signals by scanning until a beacon signal is detected. Once a beacon signal is detected, the device 115 may attempt to connect to the AP 125 and perform network authentication for joining the associated BSS/ESS of the AP 125. Once connected to the AP 125, the WLAN transceiver of devices 115 of the BSS/ESS may generally enter a sleep or low-power state between beacons if are not actively transmitting or receiving data.

In FIG. 1, devices 115-a, 115-b, and 115-c are associated with WLAN AP 125-a while devices 115-d, 115-e, 115-f, and 115-g are unconnected to WLAN AP 125-a. In some instances, devices 115-d, 115-e, 115-f, or 115-g may wish to connect with each other (e.g., using P2P, etc.) or with devices 115-a, 115-b, or 115-c, without joining the BSS of WLAN AP 125-a. To connect, these devices may wake up and scan for signals from other devices for a scanning interval that may be longer than a period between signals transmitted from the other device for device discovery and connection (e.g., beacon period, etc.). Typically, the devices wake up every few seconds or tens of seconds to scan for approximately 100 ms-1 s. In addition, APs 105 of different BSSs/ESSs are typically asynchronous. While APs 105 may transmit time values within beacon signals, these time values are typically only accurate to within a few seconds, and do not allow devices 115 connected to different APs to synchronize with each other without performing scanning. For these reasons, synchronization of disconnected devices or devices connected to different APs 105 presents significant challenges and current synchronization techniques (e.g., scanning, etc.) require devices to transmit or receive for significant periods of time. Therefore, improvements in efficiency of device discovery (e.g., reduced power consumption, reduced discovery latency, reduced medium utilization) over current techniques may be desirable.

Components of system 100, such as the mobile devices 115, WLAN APs 125, and/or base stations 105, may be configured to perform pre-scheduled communication events according to a GTB. Devices implementing the GTB may be configured to awaken and exchange discovery and service capability information over pre-scheduled channels at time points determined according to the GTB. A vendor-specific or system-wide event schedule may be determined when the devices and/or networks are provisioned. Additionally or alternatively, new communication events can be scheduled for devices to perform a group rendezvous for ad-hoc networking or exchange of metadata and/or other information. The GTB may be correlated to GPS system time.

The devices may implement a GTS for providing a local source of accurate clock time relative to the GTB. The GTS may aggregate multiple sources of absolute and/or relative time including GPS and WWAN, select the most accurate source available in a given mobile environment, track source state transitions (e.g., entering and exiting GPS coverage), and manage clock drift. In one embodiment, the GTS may update the locally-stored global time value based on GPS and may manage local clock drift in-between receipt of GPS signals using relative timing of WWAN signals (e.g., pilot signals, synchronization signals, etc.). The GTS may implement an API for application level components to retrieve the global time value (e.g., epoch name, translation factor to GTB epoch, offset from the epoch base), and/or a metric of the relative accuracy of the global time value. The GTS may update the global time value for components of the device using a shared memory interface.

The devices and/or networks may implement one or more GTCs for receiving updates from the GTS and computing offsets for communication events relative to a local clock based on the updated global time values and the communication event times relative to the GTB. The GTC may correct for transport errors from transmission of the updated global time value across modules or sub-components (e.g., different IC chips, etc.) of the devices. The GTC may receive the global time updates via a shared memory interface and correct for transport error between update of the global time value by the GTS in the shared memory and receipt of the global time value at the GTC.

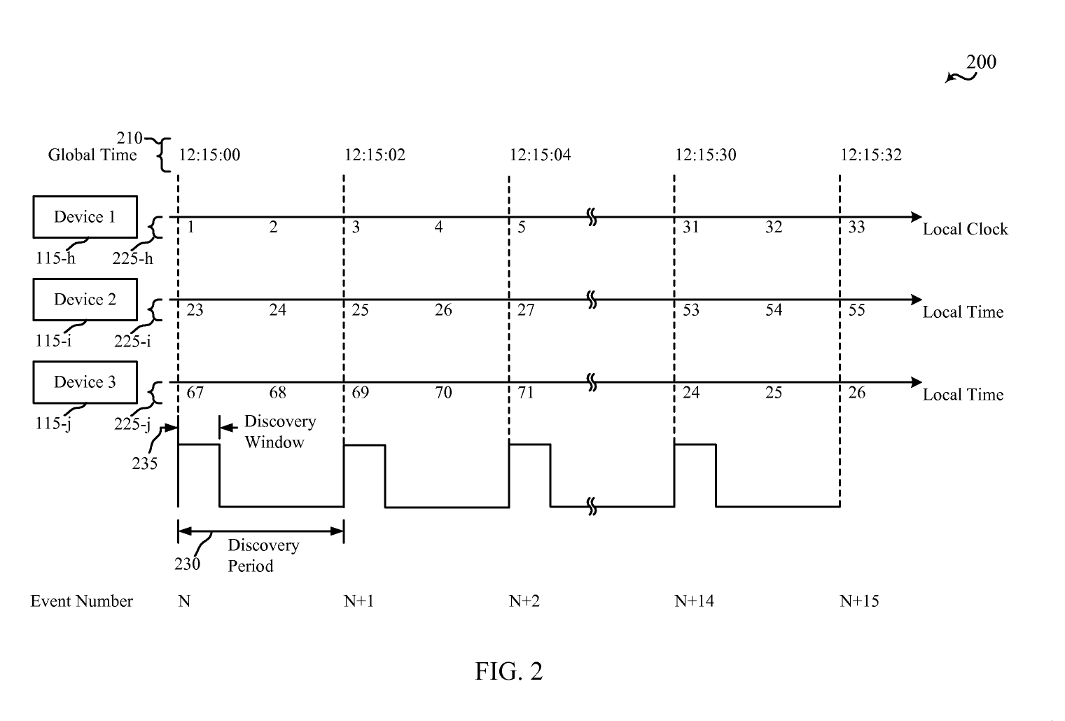

FIG. 2 is a timing diagram 200 illustrating example use of a global time base to schedule synchronous events between multiple WLAN devices. FIG. 2 illustrates devices 115-h, 115-i, and 115-j configured to wake up for a discovery window 235 in each discovery period 230. During the discovery windows 235, the devices 115-h, 115-i, and 115-j may perform device discovery of the other devices 115 and may exchange service information (e.g., broadcast service requests, broadcast services, or respond to service requests, etc.). Synchronous service discovery using a global time base may be used by devices for forming an ad-hoc or a near-me area network (NAN). While FIG. 2 illustrates synchronous service discovery for multiple devices 115, it should be appreciated that synchronous discovery using a global time base may be used by APs 105 or other networks or components that may provide or receive services from devices 115 or APs 105.

Use of a global time base may allow the devices to use a low duty cycle synchronous service discovery instead of waking up to perform scanning for longer intervals (e.g., beacon periods, etc.) to determine if other devices 115 are available for connection or exchange of services. For example, a global time base may allow devices to wake up for discovery periods that are substantially shorter than scanning durations traditionally used in WLAN networks for device discovery. In one example, devices wake up for a 20 ms discovery window every 2 s discovery period, whereas traditional WLAN techniques may require devices to wake up for approximately 600 ms every 5 s to discover other devices 115 or APs 125. In this example, not only is scan awake duty cycle reduced from 12% to 1%, but the discovery process can be executed more frequently, allowing a reduction of the delay perceived by the user (e.g., from 5 s to 2 s) to activate a particular feature.

In FIG. 2, devices 115-h, 115-i, and 115-j may be in a disconnected state (e.g., not associated with a WLAN AP 125 or part of a BSS, etc.) or may be connected to different APs. Each of the devices 115-h, 115-i, and 115-j may be configured to wake up for a discovery window 235 in each discovery period 230. The discovery period 230 and discovery window 235 may be configured according to the global time base 210. Each of the devices 115-h, 115-i, and 115-j may track an offset between a local clock 225 and the global time base 210 for determining a local clock time associated with the communication events. The offset between the local clocks 225 and the global time base 210 may change over time due to operations of the device (e.g., turning off or on, switching system clocks, etc.). For example, FIG. 2 shows that the local clock 225-j for device 115-j is reset at some point in time between events N+2 and N+15. After reset of the local clock 225-j, device 115-j re-establishes the offset between the local clock 225-j and the global time base 210 to again synchronize with the other devices 115-h and 115-i for communication event N+15 according to the global time base.

Generally, the precision of the offset of the local clock with respect to the global time base determines an uncertainty used to bracket the event windows such as discovery windows 235. For example, where the offset of the local clock is determined to have less than 5 ms of error relative to the GTB, the devices 115 may subtract the error budget from a target time for the event window. The disclosed global time server and global time client, described in more detail below, provide an accurate (e.g., 1 ms precision) offset between a local clock and the global time base that may be used to maintain synchronous discovery windows across devices 115 and APs 105.

Communication event schedules based on the global time base may include a global event time relative to the global time base and various event parameters that determine the operation or purpose of the communication events. For example, event parameters include whether the event is recurring, an event period for recurring events, a frequency band, a channel, an application or purpose for the event (e.g., notify a particular application, exchange information, perform device discovery, etc.).

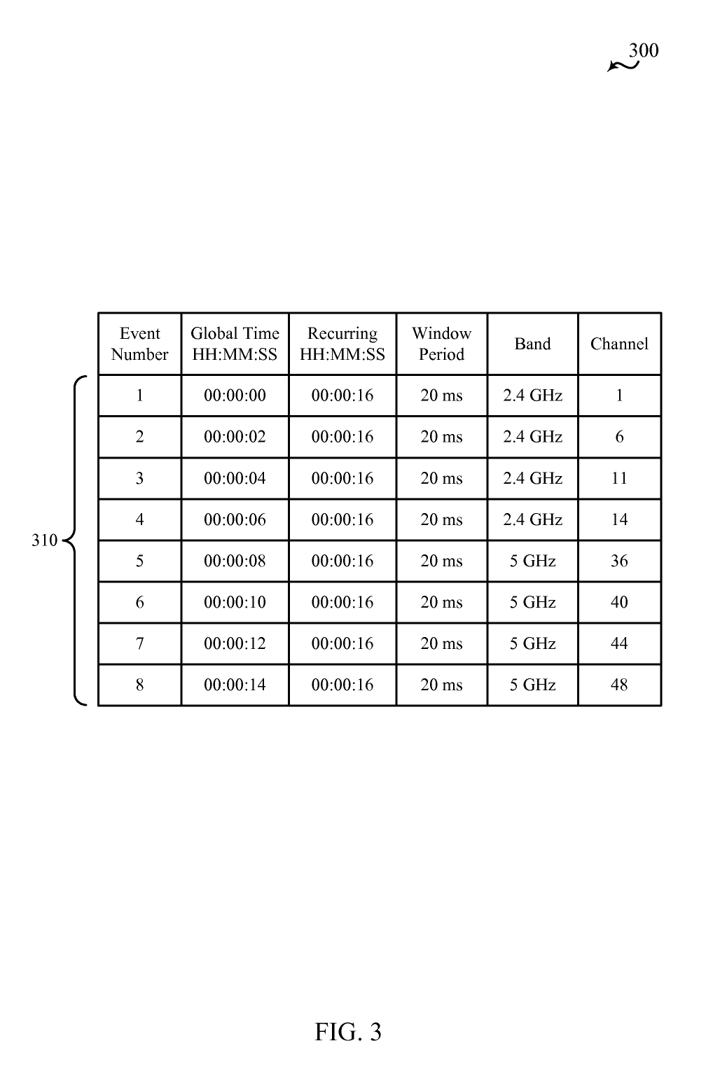

FIG. 3 illustrates an example of a global event schedule 300. Each event 310 may have an associated event number, target global time, recurring time (e.g., event period), event window, band, and/or channel. While event schedule 300 shows events associated with a WLAN radio, it should be understood that events may be associated with performing operations over other radio technologies. For example, events may be associated with performing device discovery, notification, and/or exchange of information using Bluetooth or Bluetooth low-energy (BLE). In addition, events may be associated with performing various operations over WWAN networks. For example, events may be scheduled using a global time base for paging or other discovery or notification operations over WWAN radio technologies (e.g., LTE/LTE-A, CDMA, etc.).

Global event schedules may be determined for the devices 115 when the devices are provisioned. For example, devices may be provisioned with common events for all devices and/or vendor-specific events. Once provisioned, additional events can be added to a global event schedule for group rendezvous or other purposes. For example, a number of devices 115 may form a group of “friends” with common rendezvous times correlated to the GTB and channels for rendezvous. Then, the devices in the group will be continuously aware of “friend” devices in the group and applications or services they are publishing. Thus, the user does not need to continually search or check their display for other WLAN devices with which they would like to exchange information. In addition, “friend” devices can ping other devices in the group using the common rendezvous times while reducing power consumption in device discovery as well as discovery latency for pinging. Once connected using event scheduling based on a global time base, devices can access services or applications of other devices through standard service-layer or application-layer facilities (e.g., Miracast, file sharing, chat, printing, games, etc.).

Embodiments of devices 115 and/or APs 105 implementing global time scheduling of events use a GTS for tracking global time locally at the device. In some embodiments, the GTS provides an API for allowing applications to retrieve the locally-stored global time value (e.g., epoch, offset from epoch base, etc.) and “confidence” level or metric of the relative accuracy of the global time value.

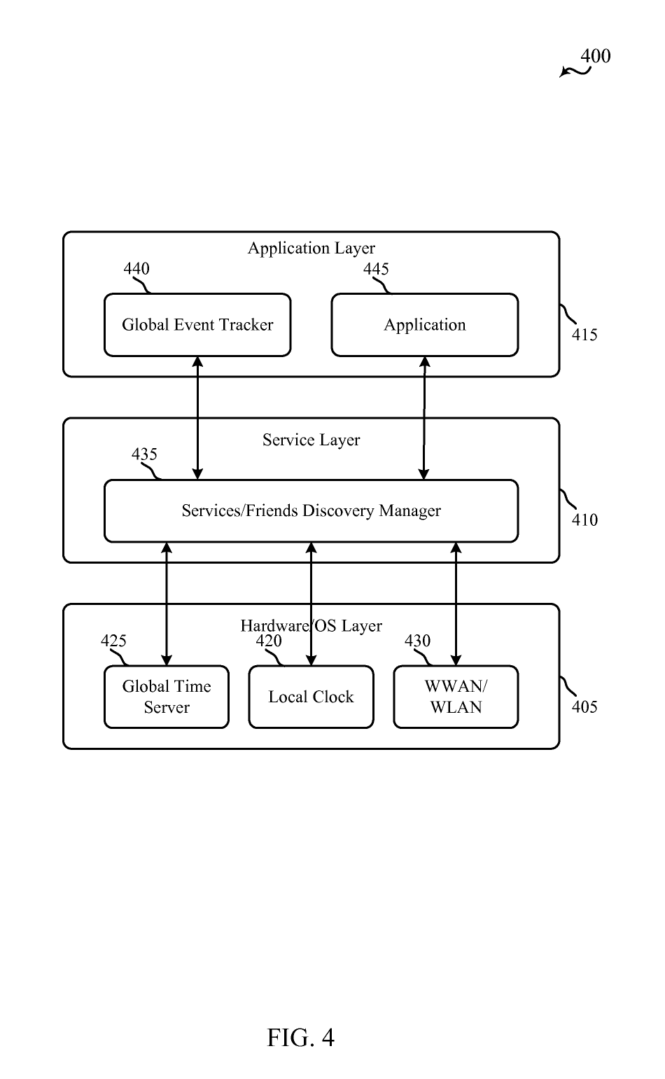

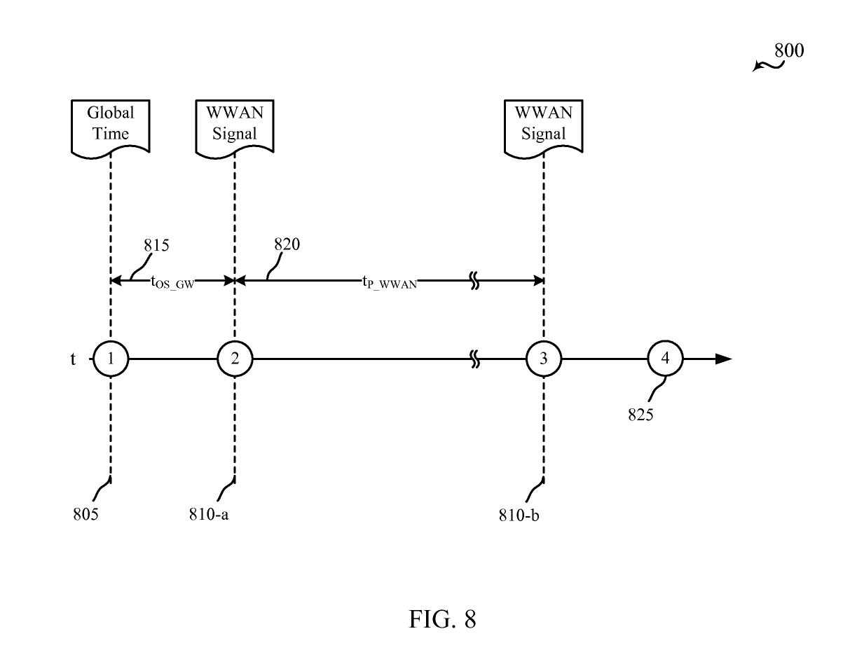

FIG. 4 illustrates an example software stack 400 implementing an API for providing global time values updated by a GTS server. The example software stack 400 includes a hardware/operating system (OS) layer 405, service layer 410, and application layer 415. The hardware/OS layer 405 may include the global time server 425, a local clock 420, and one or more wireless communication radios (e.g., WWAN, WLAN, Bluetooth, etc.) 430. The GTS 425 may track and update global time values received from one or more sources (e.g., GPS, WWAN, etc.) relative to the local clock 420. The global time server 425-a may be an example of the global time servers 425 described in more detail with reference to FIGS. 8, 9, 10, 11 or 12.

At the service layer 410, the services/friends discovery manager 435 may push global time update notifications and respond to global time value requests from global event tracker 440 and application(s) 445 at the application layer. For example, applications 445 may register with the services/friends discovery manager 435 for receiving notifications based on a group rendezvous schedule. Services/friends discovery manager 435 may, via a wireless radio 430, receive discovery information of other devices 115 or services or applications available from the other devices 115, and notify applications 445 based on the group rendezvous schedule.

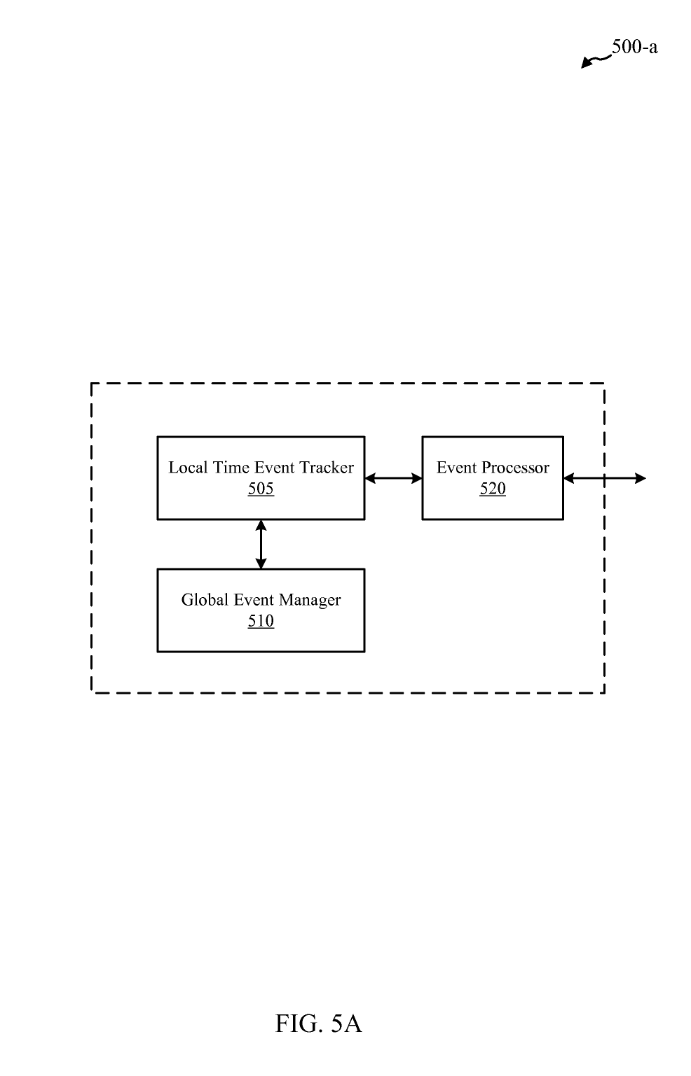

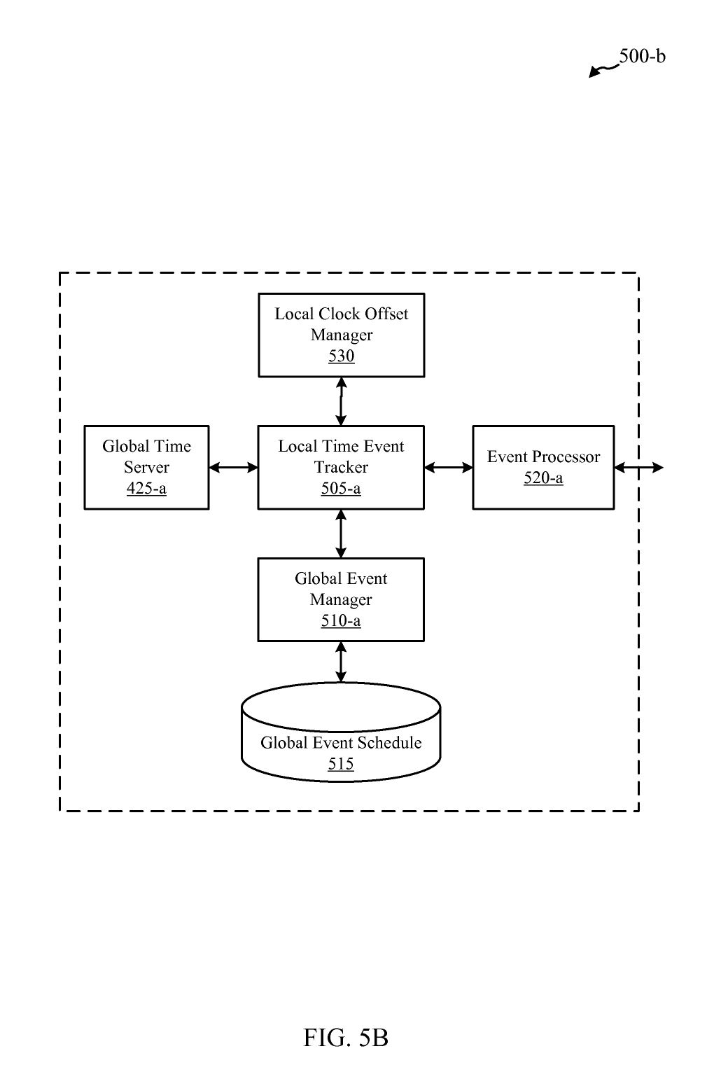

FIG. 5A shows a block diagram illustrating an example of a device 500-a that may be configured for performing communication events according to a global time base. The device 500-a may be an example of one or more aspects of the devices 115 or access points 105 described with reference to FIG. 1. The device 500-a may include a local time event tracker 505, global event manager 510, and event processor 520, each of which, in embodiments, may be communicably coupled with any or all of the other modules.

Global event manager 510 may determine a target global time value relative to a global time base for a communication event. The communication event may be, for example, a device discovery window, a group rendezvous window, or other communication event as described above. The global time base may be, for example, correlated to a global navigation system such as GPS. Global event manager 510 may indicate the target global time value for the event to the local time event tracker 505.

Local time event tracker 505 may receive the target global time value for the communication event and determine a target local time value for the communication event based at least in part on the target global time value. The target local time value may be determined using an offset of a local clock to the global time base. Local time event tracker 505 may indicate to the event processor 520 event trigger times relative to the local clock (e.g., event start, event end, etc.).

Event processor 520 may receive event trigger times from local time event tracker 505 and may manage communication (e.g., via a transceiver) for the event. For example, the event processor may determine a radio technology, channel, operation, and other parameters for the communication event.

FIG. 5B shows a block diagram illustrating an example of a device 500-b that may be configured for performing communication events according to a global time base. The device 500-b may be an example of one or more aspects of the devices 115 or access points 105 described with reference to FIG. 1. The device 500-b may include local time event tracker 505-a, global event manager 510-a, global event schedule 515, event processor 520-a, global time server 425-a, and a local clock offset manager 530, each of which, in embodiments, may be communicably coupled with any or all of the other modules. The local time event tracker 505-a, global event manager 510-a, and event processor 520-a may perform the functions of the local time event tracker 505, global event manager 510, and event processor 520 described above with reference to FIG. 5A in addition to the functionality described below for these components.

The global event manager 510-a may determine communication events using global event schedule 515. Global event schedule 515 may include events determined when the device is provisioned or may, in embodiments, include additional events determined by user interaction or device interaction with other devices (e.g., group rendezvous, etc.).

The global time server 425-a may update locally-stored global time values based on a primary GTB time source (e.g., GPS, etc.) and one or more secondary time sources (e.g., WWAN, etc.). The global time server 425-a may be an example of the global time servers 425 described in more detail with reference to FIGS. 8, 9, 10, 11 or 12.

Local time event tracker 505-a may receive target global time values for communication events from the global event manager 510-a and may receive a local clock offset from local clock offset manager 530 for offsetting the local clock relative to a global time base. The local clock offset manager 530 may implement functionality of the GTC as described in more detail below for receiving global time values from the global time server 425-a.

The components of the devices 500-a and 500-b may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors. Each of the noted components may be a means for performing one or more functions related to operation of the devices described herein.

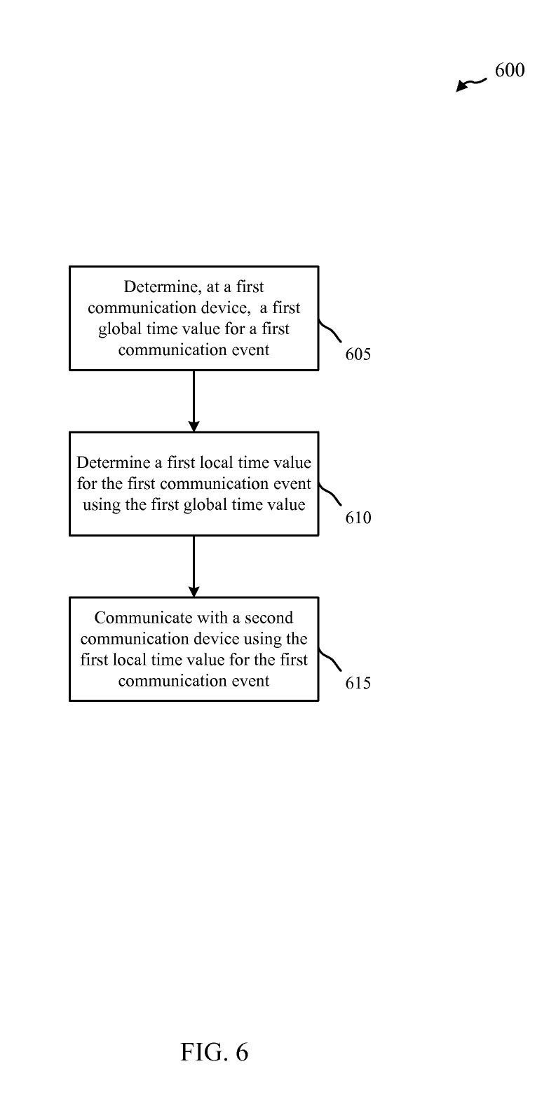

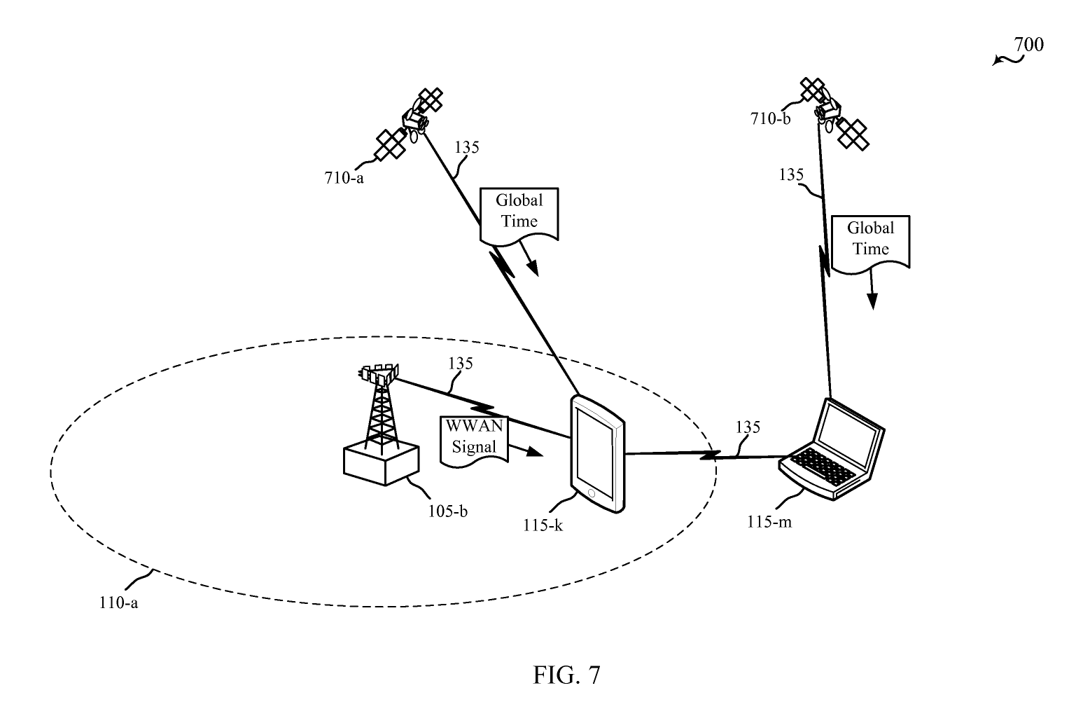

FIG. 6 is a flow chart illustrating an example of a method 600 for performing communication events according to a global time base. For clarity, the method 600 is described below with reference to one of the devices 115 shown in FIG. 1 or FIG. 7. In one implementation, the devices 500-a or 500-b described with reference to FIG. 5A or FIG. 5B may execute one or more sets of codes to control the functional elements of a device 115 or access point 105 to perform the functions described below.

Method 600 starts at block 605 where a first communication device 115 determines a first target global time value for a first communication event, where the first target global time value is related to a global time base. The communication event may be one of multiple communication events of an event schedule. The communication event may be, for example, a device discovery window, a group rendezvous window, or other communication event as described above.

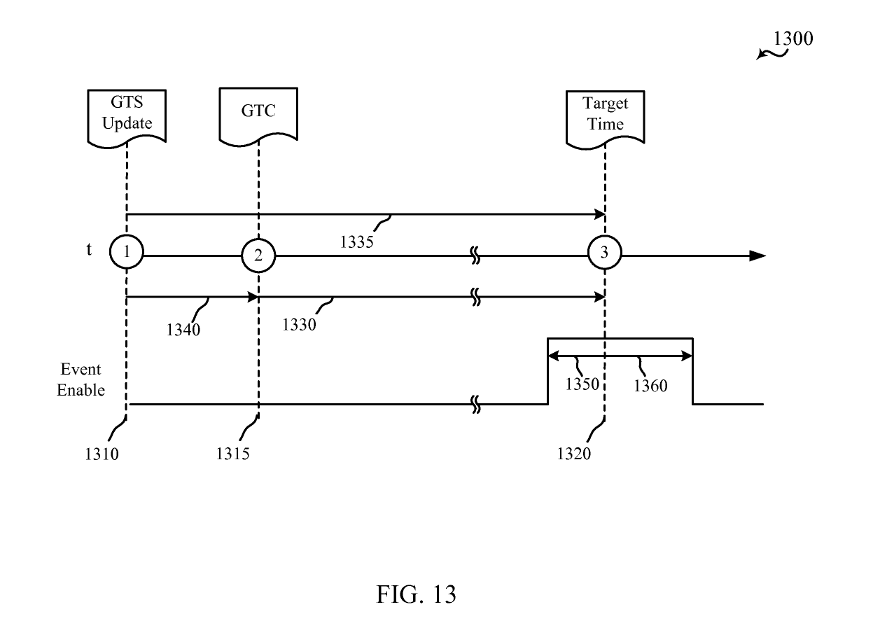

At block 610, a first target local time value is determined for the communication event using the first target global time value. For example, the first target local time value may be determined by determining an offset of the target global time value from a global update time and calculating a local clock offset to the communication event. The first local time value may be determined according to the functionality of a GTC as described below with reference to FIG. 13.

At block 615, the first communication device may communicate with a second communication device using the first local time value for the communication event. The first communication device may include, for example, waking up to perform device discovery at the first local time value, establishing a connection with the second communications device, and exchanging service information with the second communications device.

Turning to FIG. 7, a block diagram illustrates an example of a system 700 for wireless communications. The system 700 may include one or more base stations 105 associated with one or more WWAN networks (e.g., CDMA, LTE/LTE-A, etc.) and one or more wireless devices 115. Each of the wireless devices 115 may associate and communicate with base stations 105 and/or WLAN APs (not shown) via communication links 135.

Additional details of the base stations 105 and communication links 135 may be as presented above with respect to FIG. 1. In this example, both device 115-k and device 115-m are unconnected to a WLAN AP (not shown). Thus, the devices 115-k and 115-m are not synchronized with each other via a WLAN AP for communication using WLAN technologies (e.g., Wi-Fi Direct, etc.).

In embodiments, the devices 115-k and 115-m may be synchronized for a communication event with each other using a global time base (GTB), as described above. In general, the devices 115 may aggregate time sources to each accurately track the GTB. The GTB may be correlated to a primary global time system source. The primary global time system source for the GTB may be any suitable system capable of providing an accurate global time, such as a global navigation satellite system (GNSS) (e.g., the Global Positioning System (GPS), the Galileo navigation system, BeiDou Navigation Satellite System, etc.). While the primary global time system source may provide an accurate absolute time signal, various global time systems update infrequently or are not always available. For example, each complete GPS message including time update frames takes 750 seconds (12 ½ minutes). In addition, GPS signals are often lost when devices are indoors or suffer other obstructions to line of sight to GPS satellites.

As shown in FIG. 1, global time values according to the GTB may be received by the devices 115-k and 115-m from such a system, e.g., from satellites 710-a and 710-b of the GTB system (e.g., GPS). While only two satellites are illustrated with each device 115 receiving GTB values from one satellite, the devices 115-k and 115-m may receive signals from the same satellite or from multiple satellites of the GTB system.

Further in this example, the device 115-k is within the coverage area 110 for base station 105-b. Thus, the device 115-k may receive signals from the base station 105-b. As noted above, the base station 105-b may be associated with one or more WWAN networks. The device 115-k may therefore receive signals transmitted from the base station 105-b that may be used as a measure of relative time. For example, pilot signals, synchronization signals, paging signals, and the like from WWAN networks may have predetermined time periods between consecutive signals. Typically, these signals have an error rate of approximately 0.05 parts-per-million (ppm). These WWAN signals may be received from the base station 105-b by the device 115-k and may be used by the device 115-k as described below.

The devices 115-k and 115-m each may include a global time server (GTS), one or more global time clients (GTCs), and a local clock. The local clock may be configured to keep local time for the respective device 115-k/115-m. Typically, local clocks of wireless devices are derived from crystal oscillators or other timing generators that suffer from temperature dependent drift and other timing errors. For example, local clocks may have an error rate in the range of 20 ppm. In addition, devices often use multiple different timing generators based on device mode. For example, some devices use a faster timing generator (e.g., 19.2 MHz) when the device is awake and a slower timing generator (e.g., 32 kHz) while in a sleep mode.

The GTS may be configured to track the GTB using a primary time source and one or more secondary time sources to maintain an accurate offset of local time to the GTB and update global time values locally at the device. The GTCs may retrieve global time values from the GTS and correct for transport error within the device to provide local time offsets that can be used to perform pre-scheduled communication events according to the GTB as described above with respect to FIGS. 1, 2, 3, 4, 5A, 5B and/or 6.

FIG. 8 shows a timing diagram 800 that illustrates an example timeline for maintaining an offset of the GTB to the local clock at a mobile device 115. The mobile device 115 may receive a first GTB signal from the primary GTB source system at time 805. The first GTB signal may be a first global time value according to the GTB. When the first global time value is received at time 805, the device 115 may sample its local clock to obtain a first local time value.

The device 115 may then receive a first WWAN signal from the base station 105-b at time 810-a. In this example, the first WWAN signal may be a paging slot of an LTE signal. As noted above, however, the first WWAN signal may be any other suitable LTE/LTE-A, CDMA, or GSM signal, and the like. When the first WWAN signal is received at time 810-a, the device 115 may again sample its local clock to obtain a second local time value. The GTS of the device 115 may determine an offset 815 (denoted t_{OS}_{_{—}}_{GW}) between the first WWAN signal and the first global time value using the first and second local times (e.g., second local time minus first local time).

Next, the device 115 may receive a second WWAN signal (e.g., a second LTE paging slot signal) from the base station 105-b at time 810-b. When the second WWAN signal is received at time 810-b, the device 115 may again sample its local clock to obtain a third local time value.

Paging slots in LTE are of a known periodicity with the time 820 (denoted t_{P}_{₁₃} _{WWAN}) between paging slots being a constant, such as 2.56 seconds or 1.28 seconds depending on the particular LTE implementation. As such, the GTS of the device 115-k may determine a difference between the third local time value and the second local time value and compare that difference to the known time between the second WWAN signal and the first WWAN signal. Any discrepancy between the determined difference and the known time may represent drift of the local clock. Thus, the GTS may use the determined difference to compensate for local clock drift. Such an approach may be used to maintain an accurate global time value using the local clock for times in between receipt of primary source GTB signals (e.g., GPS) by the device 115.

For example, a current global time value may be determined for a given time 825 using the first global time value (received at time 805), the first WWAN signal received at time 810-a, the second WWAN signal received at time 810-b, and the corresponding local time values. The local clock may be sampled at the given time 825 to obtain a fourth local time value. The current global time value may equal a difference between the fourth and third local time values plus a difference between the third and second WWAN time values (t_{P}_{_{—}}_{WWAN}) plus a difference between the second and first local time values (t_{OS}_{_{—}}_{GW}) plus the first global time value. This may be represented as follows:

GTB time value₄=(local time value₄−local time value₃)+(WWAN time value₃−WWAN time value₂)+(local time value₂−local time value₁)+GTB time value₁

An error budget may be determined using the WWAN time values (t_{P}_{_{—}}_{WWAN}), the latch uncertainty of the local clock and the local clock drift. The period of the WWAN values t_{P}_{_{—}}_{WWAN} may be multiplied by an appropriate factor depending on the type of WWAN providing the signals. For example, the factor may be 0.05 ppm if the WWAN is an LTE network. The latch uncertainty of the local clock may be predetermined (e.g., empirically for the clock being used in the device) or may be determined during use of the clock in the device. The latch uncertainty may be multiplied by an appropriate factor. For example, the factor may be determined using the number of local clock samples involved in determining the global time value. In the example above, the factor would be four (4). The local clock drift also may be predetermined (e.g., empirically for the clock being used in the device) or may be determined during use of the clock in the device. The local clock drift may be multiplied by an appropriate factor. For example, the factor may be determined using the number of WWAN signals involved in determining the global time value and the period of the WWAN values t_{P}_{_{—}}_{WWAN}. In the example above, the factor would be two (2) times the period 820 of the WWAN value t_{P}_{_{—}}_{WWAN}.

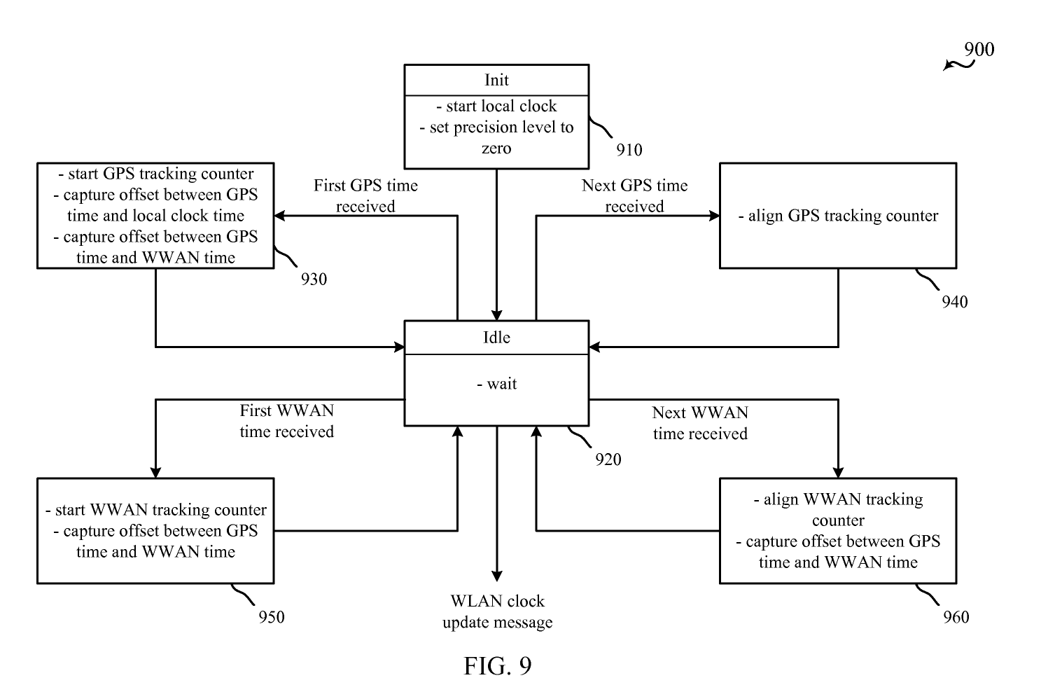

FIG. 9 illustrates an example of a state diagram 900 representing various operations and data flow for the global time server (GTS). State diagram 900 is described with to GPS as the primary source for the GTB as one example. The GTS may transition between the various states depicted in FIG. 9 in any order depending on actual timing of the various signals it receives.

The GTS may be initialized at block 910. For example, this may occur when the device 115 is turned on. Thus, the local clock may be started at block 910. Further, a precision level (discussed below) may initially set to zero. The GTS may then proceed to an idle state at block 920 where the GTS waits for receipt of a signal.

When a first GPS time value signal is received, the GTS may proceed to block 930. At block 930, the GTS may start a GPS tracking counter. The GTS may capture or otherwise determine an offset between the received GPS time value and the local clock time value. The GTS may also capture or otherwise determine an offset between the received GPS time value and a WWAN time value, if a valid WWAN time value is available. The GTS may then return to the idle state at block 920 and await receipt of another signal.

When a first WWAN time value signal is received, the GTS may proceed to block 930. At block 930, the GTS may start a WWAN tracking counter. The GTS may capture or otherwise determine an offset between the received WWAN time value and a most recent GPS time value, if a valid GPS time value is available. The GTS may then return to the idle state at block 920 and await receipt of another signal.

When a next GPS time value signal is received, the GTS may proceed to block 940. At block 940, the GTS may align the GPS tracking counter to align the local clock time with the current GPS time value. The GTS may then return to the idle state at block 920.

When a next WWAN time value signal is received, the GTS may proceed to block 950. At block 950, the GTS may align the WWAN tracking counter to align the local clock time with the current WWAN time value. The GTS may then return to the idle state at block 920.

Using information gathered from its various states, the GTS may send an update message to a client to update a client clock thereof, e.g., a WLAN clock. The update message may also include a precision level that is also determined using information gathered from the various GTS states. The precision level may be used to adjust an event window (e.g., discovery period) to ensure that communication events are successfully performed by the device 115-k, for example as described above with respect to FIG. 2.

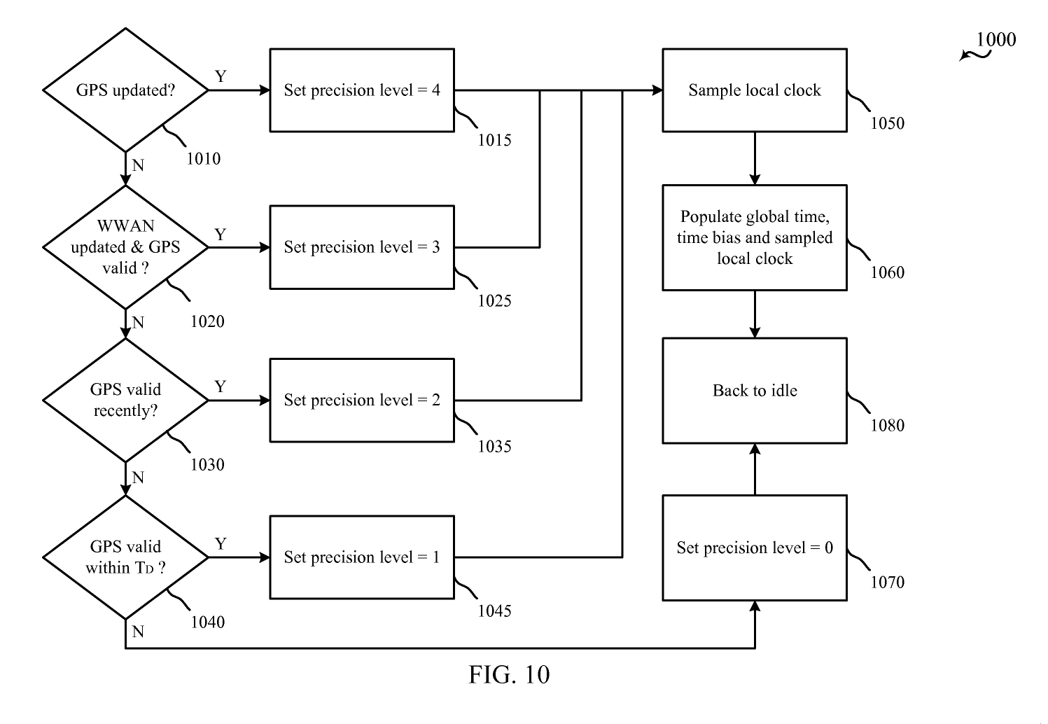

FIG. 10 shows an example of a flowchart illustrating a method 1000 that may be used to determine a precision level of locally stored global time value relative to a GTB. Although not shown as a state block in FIG. 9, the method 1000 may be considered to be implemented as part of a state of the GTS. The method may be used when an update message is sent from the GTS including a locally-stored global time value.

Beginning at block 1010, the GTS may determine whether or not an update of the locally stored global time value is updated from the primary source for the GTB (e.g., GPS, etc.). This may be performed by determining whether or not the global time value has been updated using a signal from the primary source for the GTB that was received within a first primary source threshold before the update message is to be sent. For example, the threshold may be related to a difference between the local clock time value when the GPS time value signal was received and a current local clock time value. If the global time value is considered to be updated using the primary GTB source, the method may proceed to block 1015 where the precision level may be set to 4.

If the global time value has not been updated from the primary GTB source within the first primary source threshold, the method may jump to block 1020. At block 1020, the GTS may determine whether or not the global time value is considered to be updated based on WWAN signals and the device has received a valid global time signal from the primary source. A valid global time signal may be considered to be receipt of a signal from the primary GTB source since the device has been enabled or within a second primary source threshold. The second primary source threshold may be longer than the first primary source threshold. To determine if the global time value is updated by WWAN signals, the GTS may determine whether or not the GTS has received WWAN signals continuously or substantially continuously (e.g., greater than 90%, loss only during handover, etc.) since receiving a valid signal from the primary GTB source. If the global time value is considered to be updated using WWAN signals updated and device has received a valid update from the primary GTB source, the method may proceed to block 1025 where the precision level may be set to 3.

If the global time value is not considered to be updated using WWAN signals or a valid update has not been received from the primary GTB source, the method may jump to block 1030. At block 1030, the GTS may determine whether or not the global time value has been updated by the primary GTB source within a third primary source threshold. The third primary source threshold may be longer than the second primary source threshold. If a valid update has been received from the primary GTB within the third primary source threshold, the method may proceed to block 1035 where the precision level may be set to 2.

If a valid update has not been received from the primary GTB source within the third primary source threshold, the method may jump to block 1040. At block 1040, the GTS may determine whether or not global time value is valid within a drift tolerance T_{D}. The drift tolerance T_{D} may be determined in any suitable manner. For example, T_{D} may be predetermined for the particular device 115 and set either when the device 115 is provisioned, when the device 115 is configured or when the device 115 receives a software update. Alternatively or additionally, T_{D} may be updated periodically using performance metrics of the device 115 (e.g., current drift of the local clock). In one embodiment, the drift tolerance T_{D} is event-dependent. For example, the drift tolerance T_{D} may relate to an event period of scheduled events such that outside the drift tolerance, power savings by using the GTB events is below a threshold when compared to using standard scanning techniques for device discovery and connection. If the global time value is valid within T_{D}, the method may proceed to block 1045 where the precision level may be set to 1. If the global time value is not valid within T_{D}, the method may jump to block 1070 where the precision level may be set to 0.

Once the precision level has been set to a value other than zero, the method may proceed to block 1050. At block 1050, the local clock may be sampled to determine a local time value corresponding to the update message being sent. Then at block 1060, the GTS may populate various fields of the update message, e.g., global time value, time bias (local clock offset), and the sampled local clock value (from block 1050). The CTS may then send the populated update message (e.g., as a tuple via a shared memory interface) and may return back to idle at block 1080. If the precision level is set to zero, the GTS may not send an update message to avoid an unreliable update for GTCs and may return to idle.

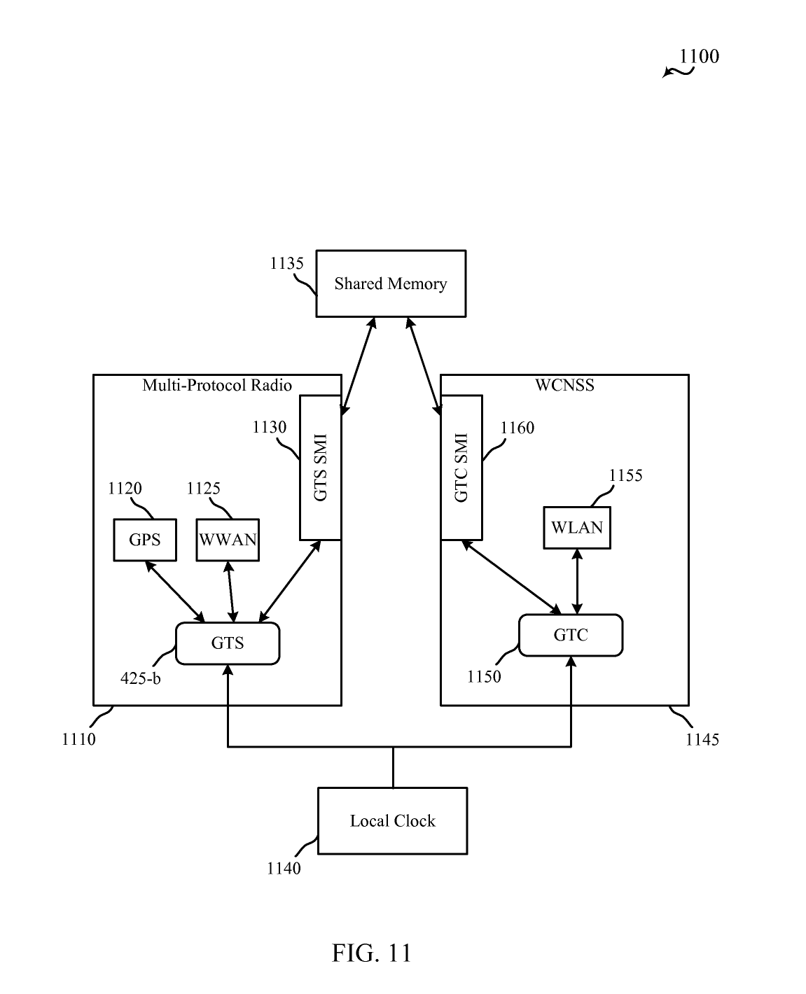

Turning now to FIG. 11, a block diagram of an example of a global time subsystem 1100 is shown. The global time subsystem 1100 may include a Multi-Protocol Radio (MPR) 1110 or similar component. The MPR 1110 may include a global time server (GTS) 425-b, a GPS manager 1120 and a WWAN manager 1125. The GPS manager 1120 may be configured to receive GPS signals and to perform any processing needed to obtain global time values from the received GPS signals. For the purposes of explanation, GPS manager 1120 is described with reference to receiving GPS signals, however, it should be understood that GPS manager 1120 may receive and process other primary GTB source signals such as other global navigation system signals in a similar manner. The WWAN manager 1125 may be configured to receive signals from one or more WWAN networks (e.g., LTE/LTE-A, CDMA, etc.) and to perform any processing needed to obtain WWAN time values or indicators of relative time periods (e.g., paging signals, etc.) from the received WWAN signals. Both the GPS manager 1120 and the WWAN manager 1125 may be in communication with the GTS to provide the GTS with the respective global and WWAN time values.

The MPR 1110 may also include a GTS shared memory interface (SMI) 1130 to allow the GTS 425-b to communicate via a shared memory 1135 of the global time subsystem 1100. Further, the global time subsystem 1110 may include a local clock 1140. The local clock 1140 may be sampled by the GTS 425-b, for example as described above.

The global time subsystem 1100 may also include a wireless connectivity subsystem (WCNSS) 1145 or similar component. The WCNSS 1145 may include a global time client (GTC) 1150, a WLAN manager 1155 and a GTC SMI 1160. The GTC SMI 1160 may allow the GTC to communicate with the GTS via the shared memory 1135. The GTC 1150 may be configured to receive global time update messages (e.g., as described above) from the GTS 425-b. The GTC 1150 may use information included in the update messages to determine the global time base (GTB) and/or a current global time value. The GTC 1140 may also sample the local clock 1140 and use a local time value to determine the current global time value (e.g., offset from a last updated global time value, etc.). The GTC 1140 may communicate the determined current global time value to the WLAN manager 1155 so that the WLAN manager 1155 may operate in accordance with the GTB and may be synchronized with other devices that are operating in accordance with the GTB.

In some embodiments, the local clock 1140 may not be part of the subsystem 1100 but may be another component of the mobile device 115. In some embodiments, the MPR 1110 and the WCNSS 1145 may be implemented on a single integrated circuit (IC) chip. In other embodiments, the MPR 1110 and the WCNSS 1145 may be implemented on separate IC chips.

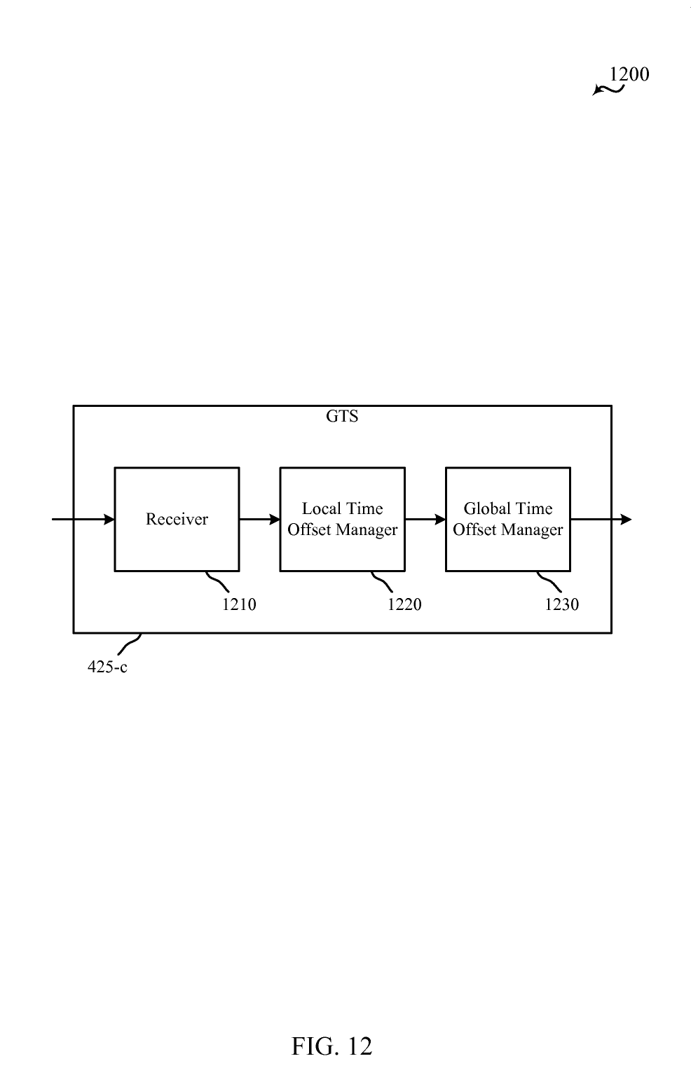

FIG. 12 shows a block diagram 1200 of an example of a GTS 425-c. The GTS 425-b may include a receiver 1210, a local time offset manager 1220 and a global time offset manager 1230, each of which may be in communication with each other. The receiver 1210 may be configured to receive GTB signals (e.g., GPS signals) and WWAN signals (e.g., LTE/LTE-A signals).

Received GTB signals may be provided to the local time offset manager 1220 either as raw signals or as global time values. The local time offset manager 1220 may be configured to convert the raw signals into global time values. The local time offset manager 1220 may also be configured determine to a local time offset of the local clock with respect to the global time values.

Received WWAN signals may be provided to the global time offset manager 1230 either as raw signals or as WWAN time values. The global time offset manager 1230 may be configured to convert the raw signals into WWAN time values. The global time offset manager 1230 may also be configured to determine a global time offset of the GTB with respect to the WWAN time values. The GTS 425-b may include the determined local and global time offsets in an update message, for example as described above.

FIG. 13 shows a timing diagram 1300 that illustrates an example timeline for determining an offset of the GTB to the local clock at a mobile device 115 for a target time. Either at or before time 1310, a communications event may be enabled for the device. The device 115 may receive a target time 1320 for the communications event to occur either before or when the event is enabled. The target time 1320 may be relative to the GTB.

The mobile device 115 may receive a first GTS update message (e.g., tuple including a global time value and local clock value) from the GTS at time 1310. The GTS update message may be received by a GTC of the device 115 at, for example, time 1315. The device 115 may then determine a local clock offset 1335 between a global time value included in the GTS update message and the target time. The determined local clock offset 1335 may be adjusted to account for transport delay between transmission of the GTS update message and receipt of the GTS update message and to account for wakeup delays. A transport delay offset 1340 may account for time delays, for example, involved in using a shared memory interface to communicate the GTS update message as described above. A wakeup delay offset 1350 may account for time delays for radio or other subsystems to wakeup, for example from a sleep mode or a powered-off mode. As such, the transport delay offset 1340 may be added to and the wakeup delay offset 1350 may be subtracted from the determined local clock offset 1335 to obtain an adjusted local clock offset 1330. This may be represented as follows:

Adjusted local clock offset=(target time₂−GTS global time value₁)+(local time value₁−local time value in message₁)−(wake up delay times)

The local clock time may be used in conjunction with the adjusted local clock offset to accurately trigger the communications event at the target time at 1320.

An error budget may be determined using the local clock offset, the local clock drift, the wakeup delay jitter (e.g., for the WLAN manager and other components), the GTS uncertainty and the latch uncertainty of the local clock (e.g., by adding these sources of error together, etc.). The error budget may be added to the wakeup delay offset 1350 such that the device will be awake and able to communicate at the target time 1320 even in the presence of factors causing error in the local clock offset 1335.

The local clock drift may be predetermined (e.g., empirically for the clock being used in the device) or may be determined during use of the clock in the device. The local clock drift may be multiplied by the determined adjusted local clock offset, for example.

The wakeup delay jitter for each component involved may be predetermined (e.g., empirically for the component being used in the device) or may be determined during use of the component in the device.

The GTS uncertainty also may be predetermined (e.g., empirically for the GTS being used in the device) or may be determined during operation of the GTS in the device (e.g., according to the techniques described above with reference to FIG. 10). The GTS uncertainty may be accounted for in the error budget by using an appropriate factor. The mobile device may also modify scanning or connection behavior at the target time 1320 based on the GTS uncertainty. For example, the mobile device 115 may determine to default to a traditional scanning window when the GTS uncertainty is at or below a threshold (e.g., a value of 0 or 1 as discussed above with reference FIG. 10, etc.). In these circumstances, the mobile device 115 may align the scanning window with the target time 1320 or with a periodicity of target times 1320.

The latch uncertainty of the local clock may be predetermined (e.g., empirically for the clock being used in the device) or may be determined during use of the clock in the device. The latch uncertainty may be multiplied by an appropriate factor. For example, the factor may be determined using the number of local clock samples involved in determining the local clock offset.

The mobile device 115 may also determine a time period 1360 to remain awake after the target time 1320 based on the local clock drift, the GTS uncertainty, and the latch uncertainty of the local clock. If a connection is established with another device 115 or AP 125 for the communication event associated with the target time 1320, the mobile device 115 may stay awake for time periods associated with transferring information for the connection.

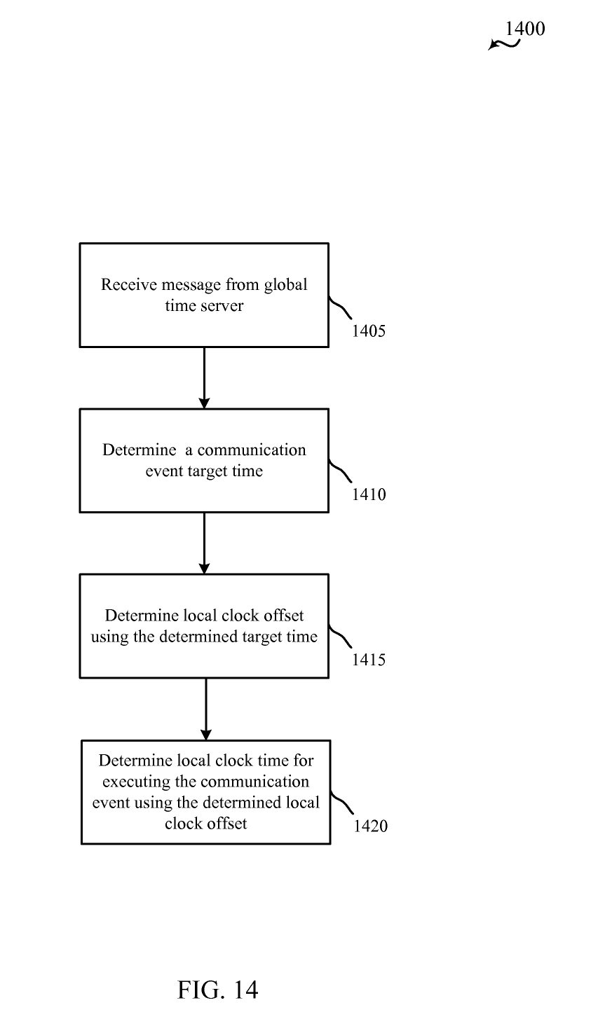

FIG. 14 shows an example of a flowchart illustrating a method 1400 that may be used to determine a local clock time for executing a communication event. Beginning at block 1405, a message may be received from a global time server (GTS). This message may include various information as described above with respect to FIGS. 9, 10, 11, 12 and/or 13.

At block 1410, a communication target time may be determined The target time may be determined via a message from a communication event scheduler and/or may be locally stored at the device 115. The device 115 may receive or otherwise obtain the target time for the communication event to occur either before or when an event is enabled, for example. Thus, the determination of the target time may occur before or after the message is received from the GTS.

Next at block 1415, a local clock offset may be determined using the determined target time. The local clock offset may also be determined using information included the GTS message, such as a global time value and/or a corresponding local time value. Further, determining the local clock offset may involve a local time value corresponding to when the GTS message was received and/or wakeup time delays as described above, for example.

Then at block 1420, a local clock time for executing the communication event may be determined using the determined local clock offset. Thus, the local clock may be used to accurately trigger the communication event using the determined local clock offset.

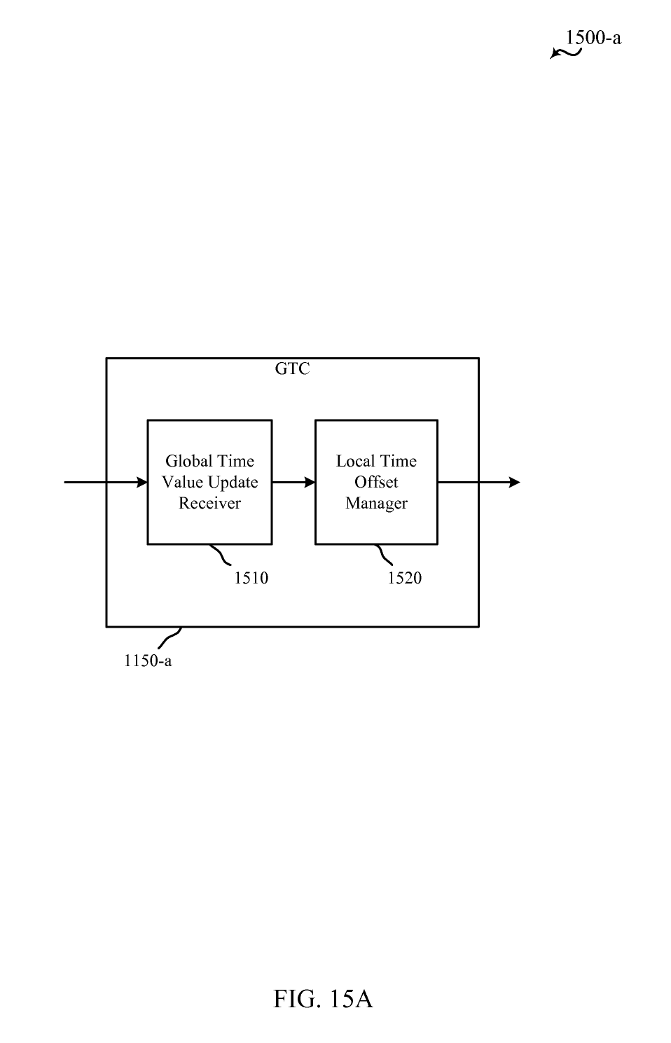

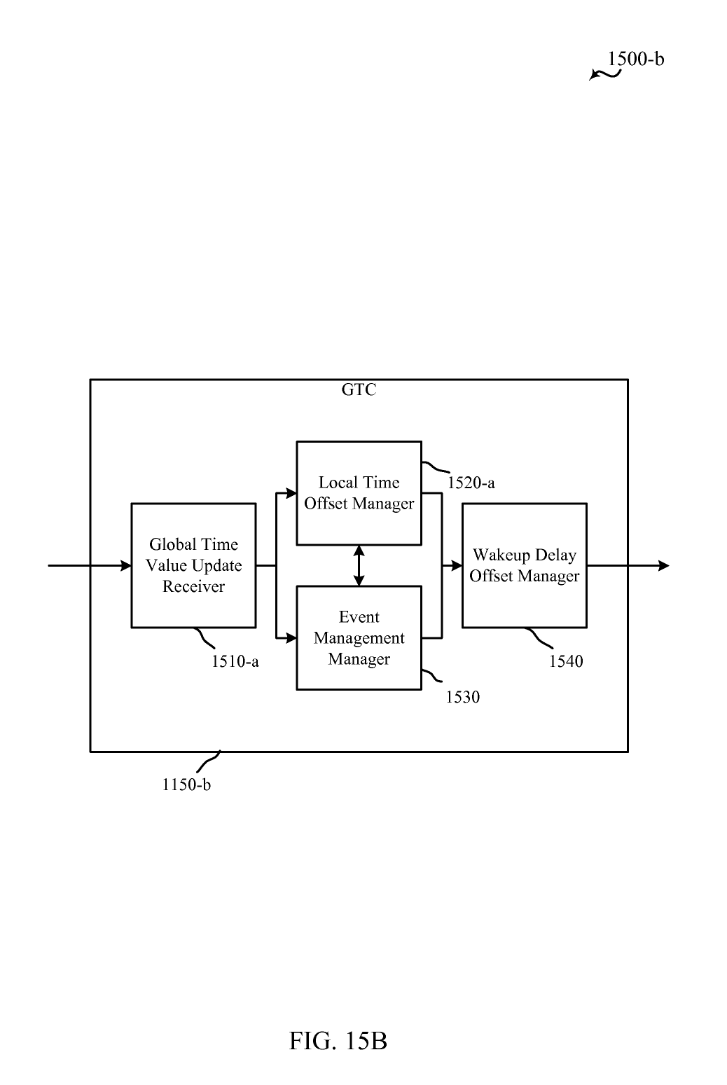

FIG. 15A shows a block diagram 1500-a of an example of a GTC 1150-a. The GTC 1150-a may include a global time value update receiver 1510 and a local time offset manager 1520, each of which, in embodiments, may be communicably coupled with any or all of the other components. The global time value update receiver 1510 may be configured to receive global time value updates from a global client server, which may be included in GTS update messages as described above, for example.

Received global time values may be provided to the local time offset manager 1520. The local time offset manager 1520 may be configured to determine a local time offset of the local clock for determining a predetermined time that is in accordance with the GTB. The determined local time offset may allow a local clock of the device 115 to accurately determine when the predetermined time occurs.

FIG. 15B shows a block diagram 1500-b of an example of a GTC 1150-b. The GTC 1150-b may include a global time value update receiver 1510-a, a local time offset manager 1520-a, an event manager 1530 and a wakeup delay offset manager 1540, each of which, in embodiments, may be communicably coupled with any or all of the other components. The global time value update receiver 1510-a may be configured to receive global time value updates as described above for the global time value update receiver 1510 of FIG. 15A.

Received global time values may be provided to the event manager 1530 and to the local time offset manager 1520-a. The event manager 1530 may be configured to receive or otherwise access a schedule of communications events. The event manager 1530 may be configured to determine at least one communication event that is to be executed by the device 115 at a target time in accordance with the GTB. The local time offset manager 1520 may be configured to determine to a local time offset of a local clock.

The wakeup delay offset manager 1540 may be configured to determine a wakeup delay offset using known or otherwise determined time values of delays for various components of the device 115 involved in executing the communication event(s) determined by the event manager 1530. The wakeup delay offset manager 1540 may be configured to determine or otherwise obtain such time values of delays for the components in use. The wakeup delay offset manager 1540 may account for an error budget as described above with reference to FIG. 13.

The GTC 1150-b may use the determined local time offset and the determined wakeup delay offset to adjust the local clock time value. The adjusted local clock value may allow the device 115 to use the local clock to accurately trigger the communication event(s) in accordance with the corresponding target time(s).

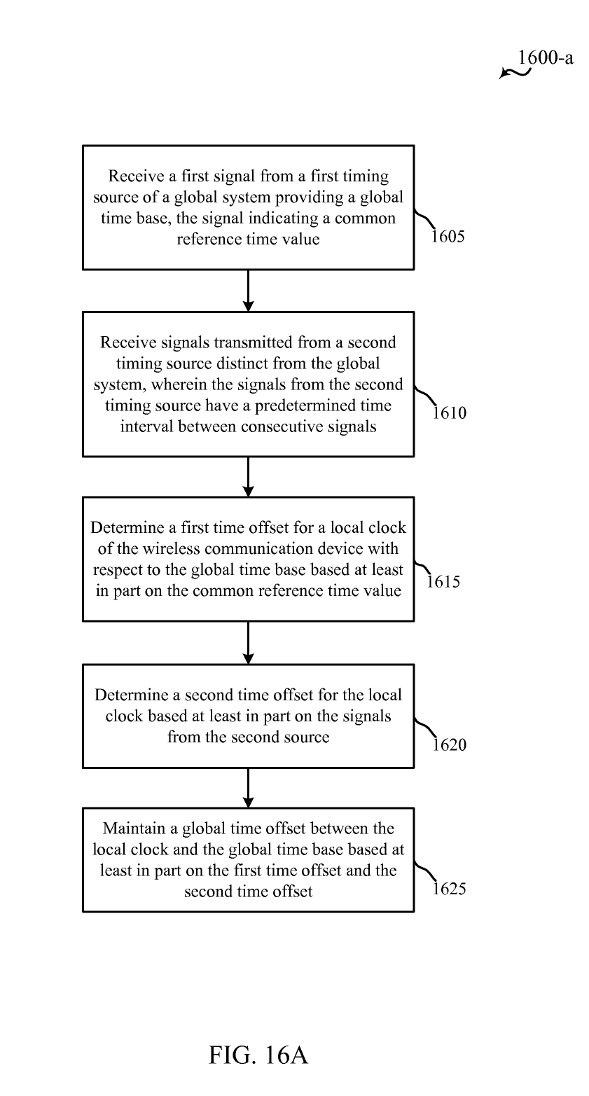

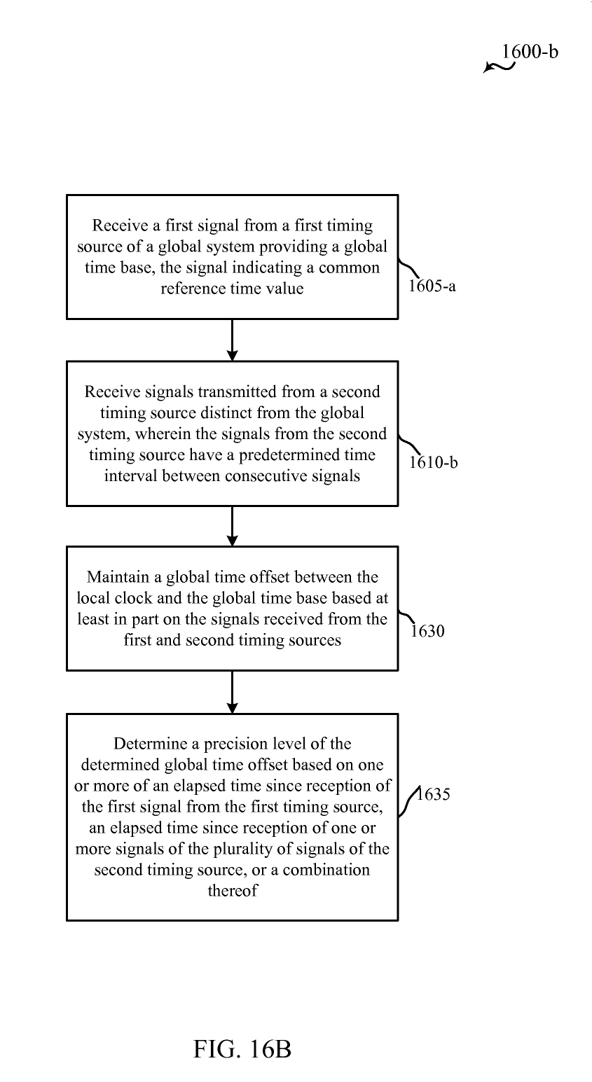

FIG. 16A shows an example of a flowchart illustrating a method 1600-a that may be used to maintain a global time offset between a local clock of a wireless communication device 115 and a global time base. Beginning at block 1605, a first signal from a first timing source of a global system providing a global time base may be received. The received signal may indicate a common reference time value or global time value. The global system providing a global time base may be GPS or the like as described above.

At block 1610, signals transmitted from a second timing source distinct from the global system may be received. The signals from the second timing source may have a predetermined time interval between consecutive signals. The second timing source may be a WWAN system (e.g., a cellular communication system) as described above.

Next at block 1615, a first time offset for a local clock of the device 115 may be determined with respect to the global time base. The first time offset may be determined using the common reference time value indicated by the first signal received from the first timing source of the global system. At block 1420, a second time offset for the local clock may be determined The second time offset may be determined using the signals received from the second timing source.

Then at block 1625, a global time offset may be maintained using the first time offset and the second time offset. For example, the second time offset may be used to supplement the first time offset so that the global time offset may be maintained in between receipt of signals from the first timing source of the global system.

FIG. 16B shows another example of a flowchart illustrating a method 1600-b that may be used to maintain a global time offset between a local clock of a wireless communication device 115 and a global time base. Beginning at block 1605-a, a first signal from a first timing source of a global system providing a global time base may be received. The received signal may indicate a common reference time value or global time value. The global system providing a global time base may be GPS or the like as described above.

At block 1610-a, signals transmitted from a second timing source distinct from the global system may be received. The signals from the second timing source may have a predetermined time interval between consecutive signals. The second timing source may be a WWAN system (e.g., a cellular communication system) as described above.

Next at block 1630, a global time offset may be maintained using the signals received from the first and second timing sources. For example, the signals from the second timing source may be used to supplement the signal from the first timing source so that the global time offset may be maintained in between receipt of signals from the first timing source of the global system.

At block 1635, a precision level of the determined global time offset may be determined This determination may be based on one or more of an elapsed time since reception of the first signal from the first timing source, an elapsed time since reception of one or more signals of the plurality of signals of the second timing source, or a combination thereof. In some embodiments, the precision level may be determined as described above with respect to FIG. 10. The precision level may be used to modify the behavior or timing of a mobile device 115 with respect to communication events synchronized to the global time base. For example, where the precision level is low the mobile device may default to traditional scanning windows for device discovery. Additionally or alternatively, the mobile device 115 may account for the precision level in determining an error budget accounted for in a wakeup delay prior to scheduled communication events using an appropriate factor.

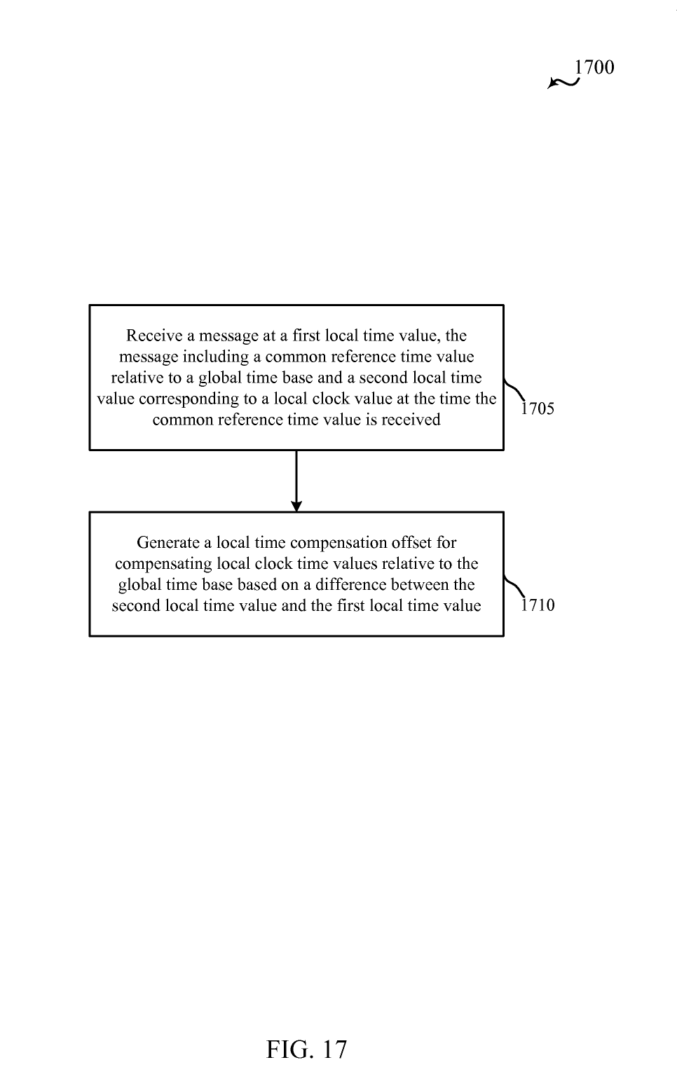

FIG. 17 shows an example of a flowchart illustrating a method 1700 that may be used to generate a local time compensation offset for compensating local clock time values.

Beginning at block 1705, a message may be received at a first local time value. The message may include a common reference time value relative to a global time base and a second local time value corresponding to a local clock value at the time the common reference time value is received. This message may be an update message from a global time server (GTS), for example as described above.

Then at block 1710, a local time compensation offset may be generated using the first and second local time values. For example, the local time compensation offset may be generated based on a difference between the second local time value and the first local time value. The generated local time compensation offset may be used for compensating time values of the local clock with respect to the global time base (GTB).

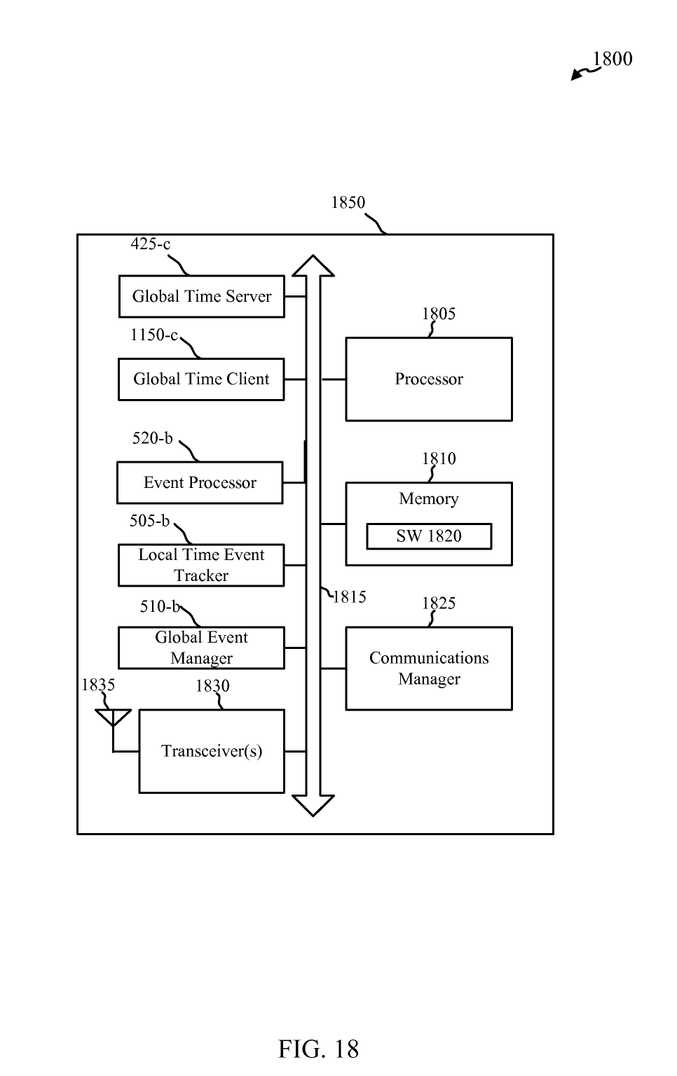

FIG. 18 shows a block diagram illustrating an example 1800 of hardware that may be used to implement a device 1850 for performing communication events according to a global time base. The device 1850 may be an example of one or more aspects of the devices 115, base station 105, or access points 125 described with reference to FIG. 1 or FIG. 7. The device 1850 may have any of various configurations, such as personal computers (e.g., laptop computers, netbook computers, tablet computers, etc.), cellular telephones, PDAs, digital video recorders (DVRs), internet appliances, gaming consoles, e-readers, WLAN APs, etc. The device 1850 may have an internal power supply (not shown), such as a small battery, to facilitate mobile operation.

The device 1850 may include a processor 1805, memory 1810, a communications manager 1825, transceiver(s) 1830, and antenna(s) 1835, which each may be in communication, directly or indirectly, with each other, e.g., via a bus 1815. The transceiver(s) 1830 may be configured to communicate bi-directionally, via the antennas 1835 and/or one or more wired or wireless links, with one or more networks, as described above. For example, the transceiver(s) 1830 may be configured to communicate bi-directionally with one or more base stations 105, access points 125, or other devices 115 described with reference to FIG. 1, FIG. 2, or FIG. 7. The transceiver(s) 1830 may include a modem configured to modulate packets and provide the modulated packets to the antenna(s) 1835 for transmission, and to demodulate packets received from the antennas(s) 1835. While the device 1850 may include a single antenna, the device 1850 will typically include multiple antennas 1835 for multiple links.

The memory 1810 may include random access memory (RAM) and/or read-only memory (ROM). The memory 1810 may store computer-readable, computer-executable software code 1820 containing instructions that are configured to, when executed, cause the processor 1805 to perform various functions (e.g., communicating with an access point, determining an event schedule, performing device discovery, etc.). Alternatively, the software code 1820 may not be directly executable by the processor 1805, but may be configured to cause the device 1850 (e.g., when compiled and executed) to perform various of the functions described herein.

The processor 1805 may include an intelligent hardware device, e.g., a central processing unit (CPU), a microcontroller, an ASIC, etc. The processor 1805 may include a speech encoder (not shown) configured to receive audio via a microphone, convert the audio into packets (e.g., 30 ms in length) representative of the received audio, provide the audio packets to the transceiver(s) 1830, and provide indications of whether a user is speaking Alternatively, an encoder may only provide packets to the transceiver(s) 1830, with the provision or withholding/suppression of the packet itself providing the indication of whether a user is speaking.

According to the architecture of FIG. 18, the device 1850 may further include a communications manager 1825, a global time server 425-c, a global time client 1150-c, an event processor 520-b, a local time event tracker 505-b, and/or a global event manager 510-b. By way of example, the components 1825, 425-c, 1150-c, 520-b, 505-b, and/or 510-b may be in communication with some or all of the other components of the device 1850 via the bus 1815. Alternatively, functionality of the components 1825, 425-c, 1150-c, 520-b, 505-b, and/or 510-b may be implemented as a component of the transceiver(s) 1830, as a computer program product, and/or as one or more controller elements of the processor 1805.

The communications manager 1825 may be configured to manage or otherwise control various communication operations of the device 1850. In particular, the communications manager 1825 may support operations of the global time server 425-c, global time client 1150-c, event processor 520-b, local time event tracker 505-b, and/or global event manager 510-b that involve receiving time signals from time sources (e.g., GPS, WWAN, etc.), updating global time values, determining local time values for communication events based on global time values, and performing communication events as described above.

The global time server 425-c may be configured to determine global time values, determine precision levels associated with the global time values, and send global time update messages to components of the device 1850 such as global time client 1150-c. In particular, the global time server 425-c may be employed to implement the components 1210, 1220, and 1230 described above with respect to FIG. 12, and thus may be configured to carry out such functionality.

The global time client 1150-c may be configured to receive global time value updates from the global time server 425-c. In particular, the global time client 1150-c may be employed to implement the functionality described above with respect to the global time clients 1150 of FIGS. 11, 15A, or 15B.

Global event manager 510-b may determine a target global time value relative to a global time base for communication events. In particular, the global event manager 510-b may be employed to implement the functionality described above with respect to the global event managers 510 of FIGS. 5A and 5B.

Local time event tracker 505-b may receive the target global time value for the communication event and determine a target local time value for the communication event based at least in part on the target global time value. In particular, the local time event tracker 505-b may be employed to implement the functionality described above with respect to the local time event trackers 505 of FIGS. 5A and 5B.

The event processor 520-b may receive event trigger times from local time event tracker 505 and may manage communication (e.g., via communications manager 1825 or transceiver 1830) for the communication events. In particular, the event processor 520-b may be employed to implement the functionality described above with respect to the event processors 520 of FIGS. 5A and 5B.

The components of the device 1850 may, individually or collectively, be implemented with one or more ASICs adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted components may be a means for performing one or more functions related to operation of the device 1850.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description, however, describes an LTE system for purposes of example, and LTE terminology is used in much of the description, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and components described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method comprising:
determining, at a first communication device, a first global time value for a first communication event, the first global time value related to a global time base;
determining a first local time value for the first communication event based at least in part on the first global time value; and
communicating with at least a second communication device according to the determined first local time value for the first communication event.

2. The method of claim 1, further comprising:
determining, at the first communication device, an event schedule comprising a plurality of communication events, each of the plurality of communication events associated with a global time value correlated to the global time base.

3. The method of claim 2, wherein the event schedule is provisioned for the first communication device according to a device class of the first communication device.

4. The method of claim 1, wherein communicating with the at least the second communication device comprises:
transitioning from a sleep state to an awake state for a device discovery window at the determined first local time value for the first communication event;
establishing a connection with the at least the second communication device in the device discovery window; and
exchanging service information with the at least the second communication device over the established connection.

5. The method of claim 1, further comprising:
establishing a group rendezvous event schedule with the at least the second communication device, the group rendezvous event schedule comprising a second, future communication event.

6. The method of claim 1, further comprising:
determining a communication channel associated with the first communication event for communicating with the at least the second communication device.

7. The method of claim 1, wherein determining the first local time for the first communication event comprises:
determining an offset of a local clock to the global time base based at least in part on at least one of signals from one or more entities of a global navigation system, signals from a wireless wide area network (WWAN), and a combination thereof

8. The method of claim 7, wherein the local clock comprises a system clock of the first communication device.

9. The method of claim 1, further comprising:
receiving the first communication event from an application layer of the first communication device.

10. The method of claim 1, wherein the global time base is correlated to Global Positioning System (GPS) system time.

11. The method of claim 1, wherein communicating with the at least the second communication device is performed over a wireless local area network (WLAN) interface.

12. An apparatus, comprising:
means for determining, at a first communication device, a first global time value for a first communication event, the first global time value related to a global time base;
means for determining a first local time value for the first communication event based at least in part on the first global time value; and
means for communicating with at least a second communication device according to the determined first local time value for the first communication event.

13. The apparatus of claim 12, further comprising:
means for determining, at the first communication device, an event schedule comprising a plurality of communication events, each of the plurality of communication events associated with a global time value correlated to the global time base.

14. The apparatus of claim 13, wherein the event schedule is provisioned for the first communication device according to a device class of the first communication device.

15. The apparatus of claim 12, wherein the means for communicating with the at least the second communication device transitions from a sleep state to an awake state for a device discovery window at the determined first local time value for the first communication event, establishes a connection with the at least the second communication device in the device discovery window, and exchanges service information with the at least the second communication device over the established connection.

16. The apparatus of claim 12, further comprising:
means for establishing a group rendezvous event schedule with the at least the second communication device, the group rendezvous event schedule comprising a second, future communication event.

17. The apparatus of claim 12, further comprising:
means for determining a communication channel associated with the first communication event for communicating with the at least the second communication device.

18. The apparatus of claim 12, wherein the means for determining the first local time for the first communication event determines an offset of a local clock to the global time base based at least in part on at least one of signals from one or more entities of a global navigation system, signals from a wireless wide area network (WWAN), and a combination thereof

19. The apparatus of claim 18, wherein the local clock comprises a system clock of the first communication device.

20. The apparatus of claim 12, further comprising:
means for receiving the first communication event from an application layer of the first communication device.

21. The apparatus of claim 12, wherein the global time base is correlated to Global Positioning System (GPS) system time.

22. The apparatus of claim 12, wherein the means for communicating with the at least the second communication device communicates over a wireless local area network (WLAN) interface.

23. A computer program product for a communication device, the computer program product comprising a non-transitory computer-readable medium, the non-transitory computer-readable medium comprising instructions executable by a processor to:
determine, at the communication device, a first global time value for a first communication event, the first global time value related to a global time base;
determine a first local time value for the first communication event based at least in part on the first global time value; and
communicate with at least a second communication device according to the determined first local time value for the first communication event.

24. The computer program product of claim 23, wherein the non-transitory computer-readable medium further comprises instructions executable by the processor to:
determine, at the communication device, an event schedule comprising a plurality of communication events, each of the plurality of communication events associated with a global time value correlated to the global time base.

25. The computer program product of claim 23, wherein the non-transitory computer-readable medium further comprises instructions executable by the processor to:
transition from a sleep state to an awake state for a device discovery window at the determined first local time value for the first communication event;
establish a connection with the at least the second communication device in the device discovery window; and
exchange service information with the at least the second communication device over the established connection.

26. The computer program product of claim 23, wherein the non-transitory computer-readable medium further comprises instructions executable by the processor to:
establish a group rendezvous event schedule with the at least the second communication device, the group rendezvous event schedule comprising a second, future communication event.

27. The computer program product of claim 23, wherein the non-transitory computer-readable medium further comprises instructions executable by the processor to:
determine a communication channel associated with the first communication event for communicating with the at least the second communication device.

28. The computer program product of claim 23, wherein the non-transitory computer-readable medium further comprises instructions executable by the processor to:
receive the first communication event from an application layer of the first communication device.

29. The computer program product of claim 23, wherein the global time base is correlated to Global Positioning System (GPS) system time.

30. The computer program product of claim 23, wherein the non-transitory computer-readable medium further comprises instructions executable by the processor to:
communicate with the at least the second communication device communicates over a wireless local area network (WLAN) interface.
